(19) United States
(12) Patent Application Publication
(10) Pub. No.: US 2025/0328777 A1
(43) Pub. Date: Oct. 23, 2025

(54) VIRTUAL METROLOGY METHOD BASED ON KEEP IMPORTANT SAMPLES AND CONVOLUTIONAL NEURAL NETWORK AND SYSTEM THEREOF

(71) Applicants: NATIONAL CHENG KUNG UNIVERSITY, Tainan City (TW); MIRLE AUTOMATION CORPORATION, Hsinchu (TW)

(72) Inventors: Yu-Ming HSIEH, Tainan City (TW); Fan-Tien CHENG, Tainan City (TW); Sheng-Yu HUANG, New Taipei City (TW); Chun-Ting LIU, Tainan City (TW)

(21) Appl. No.: 18/979,687

(22) Filed: Dec. 13, 2024

(30) Foreign Application Priority Data
Apr. 23, 2024 (TW) 113115109

(51) Int. Cl. G06N 3/096; G06F 18/241; G06N 3/0455; G06N 3/0464

(52) U.S. Cl. CPC G06N 3/096; G06F 18/241; G06N 3/0455; G06N 3/0464

(57) ABSTRACT

A virtual metrology method based on keep important samples (KIS) and convolutional neural network (CNN) includes performing a modeling operation and a calculating operation. The modeling operation includes classifying paired data and unpaired process data; using the unpaired process data to create a pre-trained model, performing a KIS operation for the paired data to generate important samples, and inputting the important samples to the pre-trained model to create a virtual metrology model based on CNN and KIS. The virtual metrology model based on CNN and KIS includes at least one convolutional neural network model. The calculating operation includes a transfer learning step. The transfer learning step includes performing calculation according to the virtual metrology model based on CNN and KIS. The number of the important samples is smaller than the number of the paired data. A downsampling-based KIS scheme is used based on CAE, K-means, and cosine distance.

### RELATED APPLICATIONS

This application claims priority to Taiwan Application Serial Number 113115109, filed Apr. 23, 2024, which is herein incorporated by reference.

### BACKGROUND

### Technical Field

The present disclosure relates to a virtual metrology method and a system thereof. More particularly, the present disclosure relates to a virtual metrology method based on keep important samples (KIS) and convolutional neural network (CNN) and a system thereof.

### Description of Related Art

Stable processing and high-yield production are the continuing pursuits of the manufacturing industry, and offline sampling inspection is the most commonly adopted method to achieve such goals. However, this approach can only assess the quality of the sampled workpieces and it comes with time delay, which makes it unable to monitor product quality in real time. Owing to this inability, shifts that occur during metrology delay might result in a great production loss. Virtual Metrology (VM) technology can realize online and real-time total inspection to solve such issues. As the processes of high-tech industries (e.g., semiconductors, TFT-LCD) are getting more sophisticated, higher VM prediction accuracy is demanded.

Nevertheless, two advanced capabilities need to be addressed for its practical applications: 1) rare and imbalanced collected metrology values lead to poor prediction accuracy of the extreme values; and 2) the model can only be updated when sufficient metrology values are collected. Therefore, a virtual metrology method based on KIS and CNN and a system thereof which are capable of considering data balance and effectively enhancing the prediction accuracy are commercially desirable.

### SUMMARY

An object of the present disclosure is to provide a virtual metrology method based on KIS and CNN and a system thereof of the present disclosure utilize a downsampling-based KIS scheme based on convolutional autoencoder (CAE), K-means and cosine distance and a dual-phase algorithm improved by adopting the online KIS scheme, thereby solving a problem of a conventional scheme that has the imbalance problem and the poor prediction accuracy.

According to one aspect of the present disclosure, a virtual metrology method based on keep important samples (KIS) and convolutional neural network (CNN) includes a plurality of steps. A first one of the steps includes configuring a processor to obtain a plurality of sets of process data. The sets of process data are used or generated by a production tool when a plurality of workpieces are processed by the production tool, and the sets of process data are one-to-one corresponding to the workpieces. Each of the sets of process data includes values of a plurality of parameters, and values of each of the parameters are respectively corresponding to a plurality of sets of time series data of the workpieces, and each of the sets of time series data has a data length. A second one of the steps includes configuring the processor to perform a data alignment operation onto the sets of process data. The data alignment operation includes performing a data-length adjusting operation to repeat adding at least one data point having a value of an end data point of each of the sets of time series data of each of the parameters after the end data point until the data length of each of the sets of time series data of each of the parameters is equal to a longest data length of the sets of process data. A third one of the steps includes obtaining a plurality of actual metrology values of the workpieces. A fourth one of the steps includes configuring the processor to perform a modeling operation. The modeling operation includes classifying the sets of process data and the actual metrology values into a plurality of paired data and at least one unpaired process data. Each of the paired data includes one of the sets of process data and one of the actual metrology values corresponding to the one of the sets of process data. In addition, the modeling operation further includes creating at least one pre-trained model by using the at least one unpaired process data, performing a keep important samples operation on the paired data to generate a plurality of important samples, and then inputting the important samples to the at least one pre-trained model to create a virtual metrology model based on convolutional autoencoder with keep important samples. The virtual metrology model based on convolutional autoencoder with keep important samples includes at least one convolutional neural network model. A fifth one of the steps includes configuring the processor to perform a calculating operation. The calculating operation includes obtaining at least one of another set of process data and another actual metrology value of another workpiece, and executing one of a predicting step and a transfer learning step according to whether the another actual metrology value is obtained, thereby calculating one of a phase-one virtual metrology value and a phase-two virtual metrology value of the another workpiece. The transfer learning step includes performing calculations according to the virtual metrology model based on convolutional autoencoder with keep important samples, and a number of the important samples is smaller than a number of the paired data.

Therefore, the virtual metrology method based on KIS and CNN of the present disclosure utilizes a downsampling-based KIS scheme based on CAE, K-means, and cosine distance. The KIS scheme aims to balance the retention of the important samples within each value range for effectively resolving the imbalance problem and enhancing the model's learning effectiveness during fine-tuning, which facilitates advanced automatic virtual metrology to have wider application in the more and more sophisticated semiconductor industry.

In some embodiments, the keep important samples operation includes judging that each of the paired data belongs to one of an extreme keeping group and a selective keeping group according to a distribution of the paired data, and performing downsampling on a part of the paired data belonging to the selective keeping group to obtain a plurality of keeping data. The important samples include another part of the paired data belonging to the extreme keeping group and the keeping data.

In some embodiments, the distribution of the paired data is a normal distribution. The keep important samples operation further includes dividing the normal distribution into the extreme keeping group and the selective keeping group according to a judgment condition, and dividing the paired data into the part of the paired data and the another part of the paired data according to the extreme keeping group and the selective keeping group.

In some embodiments, the judgment condition is calculated as follows:

$$p {σ}_{y} \leq \frac{{y}_{i} - \overline{y}}{{σ}_{y}} ; and$$

$$\frac{{y}_{i} - \overline{y}}{{σ}_{y}} < - p {σ}_{v} ;$$

where p represents a parameter which is greater than 1 and smaller than or equal to 2; yᵢ represents ith actual metrology value; y̅ represents an average value of yᵢ; σ_{y} represents a standard deviation of yᵢ, y̅ and σ_{y} are calculated as follows:

$$\overline{y} = \frac{{\sum }_{i = 1}^{n} {y}_{i}}{n} ; and$$

$${σ}_{y} = \sqrt{\frac{{( {y}_{i} - \overline{y} )}^{2}}{( n - 1 )}} ;$$

where n represents a sample size of yᵢ, in the normal distribution, the part of the paired data that meets the judgment condition belongs to the extreme keeping group, and the another part of the paired data that does not meet the judgment condition belongs to the selective keeping group.

In some embodiments, the keep important samples operation further includes clustering the another part of the paired data into a plurality of data groups according to a grouping algorithm, and setting a threshold value for the data groups, and calculating a group center and two percentage parameters of each of the data groups according to the threshold value. The threshold value is represented by

$${D}_{cos {θ}_{{mk}_{T}}}$$

and calculated as follows:

$${D}_{{cos θ}_{{mk}_{T}}} = {\overline{{D}_{cos θ}}}_{mk} + α \times {σ}_{{D}_{{cos θ}_{m k}}} ;$$

$${\overline{{D}_{cos θ}}}_{mk} = \frac{{\sum }_{c = 1}^{b} {\sum }_{b = c + 1}^{q} {D}_{{cos θ}_{mkcb}}}{( q \times \frac{q - 1}{2} )} ; and$$

$${σ}_{{D}_{{cos θ}_{mk}}} = \sqrt{\frac{{( ( {\sum }_{c = 1}^{b} {\sum }_{b = c + 1}^{q} {D}_{{cos θ}_{{mk}_{cb}}} ) - {\overline{{D}_{cos θ}}}_{mk} )}^{2}}{( q \times \frac{q - 1}{2} )}} ;$$

where [symbol] represents an average value of a cosine distance between two samples in kth cluster of the data groups of mth group;

$${σ}_{{D}_{cos {θ}_{mk}}}$$

represents a standard deviation of the cosine distance between the two samples in the kth cluster of the data groups of the mth group;

$${D}_{cos {θ}_{{mk}_{cb}}}$$

represents a cosine distance between a vector of bth sample and a vector of cth sample in the kth cluster of the data groups of the mth group; a represents a threshold setting factor; b and c belong to q and are different from each other; and q represents a sample number of the mth group.

In some embodiments, the keep important samples operation further includes segmenting one of the data groups into a plurality of sections according to the group center and the two percentage parameters; and calculating a cosine distance between a sample in the one of the data groups and the group center, and performing an assignment sample operation according to the cosine distance between the sample in the one of the data groups and the group center. The assignment sample operation is performed as follows:

$$\{ \begin{matrix}if {C}_{{g}_{m , k}} \leq {D}_{cos θ} ( \vec{{g}_{m {k}_{b}}} , \vec{{Cg}_{mk}} ) \leq {D}_{{cos θ}_{{mkP}_{75}}} , {g}_{m , {k}_{b}} ∈ {S}_{mk 1} \\ if {D}_{cos {θ}_{m k {P}_{75}}} \leq {D}_{cos θ} ( \vec{{g}_{m {k}_{b}}} , \vec{{Cg}_{mk}} ) \leq {D}_{{cos θ}_{m k {P}_{90}}} , {g}_{m , {k}_{b}} ∈ {S}_{mk 2} \\ otherwise , {g}_{m , {k}_{b}} ∈ {S}_{mk 3}\end{matrix} ;$$

where C_{g}_{_{m,k}} represents the group center; D_{cos θ}({right arrow over (gₘₖ_{_{b}})}, \vec{Cgₘₖ}) represents the cosine distance between the sample in the one of the data groups and the group center;

$${D}_{cos {θ}_{{mkP}_{75}}} and {D}_{cos {θ}_{{mkP}_{90}}}$$

represent the two percentage parameters; {right arrow over (gₘₖ_{_{b}} )} represents a vector of bth sample in the kth cluster of the data groups of the mth group; \vec{Cgₘₖ} represents a vector of the group center in the kth cluster of the data groups of the mth group; g_{m,k}_{_{b}} represents the bth sample in the kth cluster of the data groups of the mth group; Sₘₖₛ represents sth section in the kth cluster of the data groups of the mth group, and s is one of 1, 2 and 3.

In some embodiments, the keep important samples operation further includes calculating a cosine distance between two samples of the sth section in the kth cluster of the data groups of the mth group. The cosine distance between the two samples of the sth section in the kth cluster of the data groups of the mth group is calculated as follows:

$${D}_{{cos θ}_{{S}_{{mks}_{ef}}}} = {D}_{cos θ} ( \vec{{S}_{mk {s}_{e}}} , \vec{{S}_{m k {s}_{f}}} ) ;$$

where \vec{Sₘₖₛ_{ₑ}} represents a vector of eth sample of the sth section in the kth cluster of the data groups of the mth group; {right arrow over (Sₘₖₛ_{_{f}} )} represents a vector of fth sample of the sth section in the kth cluster of the data groups of the mth group, and e and f are different from each other.

In some embodiments, the keep important samples operation further includes confirming whether a sample number of the sth section in the kth cluster of the data groups of the mth group is greater than a predetermined sample number to generate a confirmation result, and then deciding to execute an important sample selecting operation or an important sample obtaining operation according to the confirmation result. In response to determining that the confirmation result is yes, performing the important sample selecting operation, the important sample obtaining operation and an all sample checking operation in sequence. In response to determining that the confirmation result is no, performing the important sample obtaining operation and the all sample checking operation in sequence. The important sample selecting operation includes selecting three samples with a largest cosine distance in the sth section of the kth cluster of the data groups of the mth group, and moving the three samples into an important sample set. The important sample obtaining operation includes obtaining the important samples of the important sample set. The all sample checking operation includes confirming whether all samples are checked.

In some embodiments, the transfer learning step of the calculating operation further includes regarding the another actual metrology value as a new sample, and calculating a cosine distance between the new sample and the group center in the kth cluster of the data groups of the mth group, and performing the assignment sample operation according to the cosine distance between the new sample and the group center in the kth cluster of the data groups of the mth group, and confirming whether the new sample becomes another important sample.

In some embodiments, the predicting step includes calculating the phase-one virtual metrology value by the another set of process data according to the virtual metrology model based on convolutional autoencoder with keep important samples, and the transfer learning step further includes calculating the phase-two virtual metrology value by the another set of process data and the another actual metrology value according to the virtual metrology model based on convolutional autoencoder with keep important samples. The virtual metrology model based on convolutional autoencoder with keep important samples controls the production tool to process the workpieces. The production tool is corresponding to each of the phase-one virtual metrology value generated in the predicting step and the phase-two virtual metrology value generated in the transfer learning step, and the production tool adopts a dry etching process of semiconductor manufacturing.

According to another aspect of the present disclosure, a virtual metrology system based on keep important samples (KIS) and convolutional neural network (CNN) includes a memory and a processor. The memory is configured to store a plurality of sets of process data and a plurality of actual metrology values of a plurality of workpieces. The sets of process data are used or generated by a production tool when the workpieces are processed by the production tool, and the sets of process data are one-to-one corresponding to the workpieces. Each of the sets of process data includes values of a plurality of parameters, and values of each of the parameters are respectively corresponding to a plurality of sets of time series data of the workpieces, and each of the sets of time series data has a data length. The processor is electrically connected to the memory. The processor receives the sets of process data and the actual metrology values, and is configured to perform a data alignment operation, a modeling operation and a calculating operation. The data alignment operation is performed onto the sets of process data. The data alignment operation includes performing a data-length adjusting operation to repeat adding at least one data point having a value of an end data point of each of the sets of time series data of each of the parameters after the end data point until the data length of each of the sets of time series data of each of the parameters is equal to a longest data length of the sets of process data. The modeling operation includes classifying the sets of process data and the actual metrology values into a plurality of paired data and at least one unpaired process data. Each of the paired data includes one of the sets of process data and one of the actual metrology values corresponding to the one of the sets of process data. In addition, the modeling operation further includes creating at least one pre-trained model by using the at least one unpaired process data, performing a keep important samples operation on the paired data to generate a plurality of important samples, and then inputting the important samples to the at least one pre-trained model to create a virtual metrology model based on convolutional autoencoder with keep important samples. The virtual metrology model based on convolutional autoencoder with keep important samples includes at least one convolutional neural network model. The calculating operation includes obtaining at least one of another set of process data and another actual metrology value of another workpiece, and executing one of a predicting step and a transfer learning step according to whether the another actual metrology value is obtained, thereby calculating one of a phase-one virtual metrology value and a phase-two virtual metrology value of the another workpiece. The transfer learning step includes performing calculations according to the virtual metrology model based on convolutional autoencoder with keep important samples, and a number of the important samples is smaller than a number of the paired data.

Therefore, the virtual metrology system based on KIS and CNN of the present disclosure utilizes the dual-phase algorithm improved by adopting the online KIS scheme. The important samples are selected to achieve real-time model refreshing and avoid the sample-imbalance issue when new samples come in. In addition, in the time-varying system, the dual-phase algorithm improved by adopting the online KIS scheme possesses the ability of model refreshing and improves the learning efficiency of the model during the fine-tuning process to ensure good prediction accuracy.

In some embodiments, the keep important samples operation includes judging that each of the paired data belongs to one of an extreme keeping group and a selective keeping group according to a distribution of the paired data, and performing downsampling on a part of the paired data belonging to the selective keeping group to obtain a plurality of keeping data. The important samples include another part of the paired data belonging to the extreme keeping group and the keeping data.

In some embodiments, the distribution of the paired data is a normal distribution. The keep important samples operation further includes dividing the normal distribution into the extreme keeping group and the selective keeping group according to a judgment condition, and dividing the paired data into the part of the paired data and the another part of the paired data according to the extreme keeping group and the selective keeping group.

In some embodiments, the judgment condition is calculated as follows:

$$p {σ}_{y} \leq \frac{{y}_{i} - \overline{y}}{{σ}_{y}} ; and$$

$${σ}_{y} = \sqrt{\frac{{( {y}_{i} - \overline{y} )}^{2}}{( n - 1 )}} ;$$

where p represents a parameter which is greater than 1 and smaller than or equal to 2; yᵢ represents ith actual metrology value; y̅ represents an average value of yᵢ; σ_{y} represents a standard deviation of yᵢ, y̅ and σ_{y} are calculated as follows:

$$\overline{y} = \frac{{\sum }_{i = 1}^{n} {y}_{i}}{n} ; and$$

$${σ}_{y} = \sqrt{\frac{{( {y}_{i} - \overline{y} )}^{2}}{( n - 1 )}} ;$$

where n represents a sample size of yᵢ, in the normal distribution, the part of the paired data that meets the judgment condition belongs to the extreme keeping group, and the another part of the paired data that does not meet the judgment condition belongs to the selective keeping group.

In some embodiments, the keep important samples operation further includes clustering the another part of the paired data into a plurality of data groups according to a grouping algorithm, and setting a threshold value for the data groups, and calculating a group center and two percentage parameters of each of the data groups according to the threshold value. The threshold value is represented by

$${D}_{cos {θ}_{{mk}_{T}}}$$

and calculated as follows:

$${D}_{{cos θ}_{{mk}_{T}}} = {\overline{{D}_{cos θ}}}_{mk} + α \times {σ}_{{D}_{{cos θ}_{m k}}} ;$$

$${\overline{{D}_{cos θ}}}_{mk} = \frac{{\sum }_{c = 1}^{b} {\sum }_{b = c + 1}^{q} {D}_{{cos θ}_{mkcb}}}{( q \times \frac{q - 1}{2} )} ; and$$

$${σ}_{{D}_{{cos θ}_{mk}}} = \sqrt{\frac{{( ( {\sum }_{c = 1}^{b} {\sum }_{b = c + 1}^{q} {D}_{{cos θ}_{{mk}_{cb}}} ) - {\overline{{D}_{cos θ}}}_{mk} )}^{2}}{( q \times \frac{q - 1}{2} )}} ;$$

where [symbol] represents an average value of a cosine distance between two samples in kth cluster of the data groups of mth group;

$${σ}_{{D}_{cos {θ}_{mk}}}$$

represents a standard deviation of the cosine distance between the two samples in the kth cluster of the data groups of the mth group;

$${D}_{cos {θ}_{{mk}_{cb}}}$$

represents a cosine distance between a vector of bth sample and a vector of cth sample in the kth cluster of the data groups of the mth group; α represents a threshold setting factor; b and c belong to q and are different from each other; and q represents a sample number of the mth group.

In some embodiments, the keep important samples operation further includes segmenting one of the data groups into a plurality of sections according to the group center and the two percentage parameters; and calculating a cosine distance between a sample in the one of the data groups and the group center, and performing an assignment sample operation according to the cosine distance between the sample in the one of the data groups and the group center. The assignment sample operation is performed as follows:

$$\{ \begin{matrix}if {C}_{{g}_{m , k}} \leq {D}_{cos θ} ( \vec{{g}_{m {k}_{b}}} , \vec{{Cg}_{mk}} ) \leq {D}_{{cos θ}_{{mkP}_{75}}} , {g}_{m , {k}_{b}} ∈ {S}_{mk 1} \\ if {D}_{cos {θ}_{m k {P}_{75}}} \leq {D}_{cos θ} ( \vec{{g}_{m {k}_{b}}} , \vec{{Cg}_{mk}} ) \leq {D}_{{cos θ}_{m k {P}_{90}}} , {g}_{m , {k}_{b}} ∈ {S}_{mk 2} \\ otherwise , {g}_{m , {k}_{b}} ∈ {S}_{mk 3}\end{matrix}$$

where C_{g}_{_{m,k}} represents the group center; D_{cos θ}({right arrow over (gₘₖ_{_{b}})}, \vec{Cgₘₖ}) represents the cosine distance between the sample in the one of the data groups and the group center;

$${D}_{cos {θ}_{{mkP}_{75}}} and {D}_{cos {θ}_{{mkP}_{90}}}$$

represent the two percentage parameters; {right arrow over (gₘₖ_{_{b}} )} represents a vector of bth sample in the kth cluster of the data groups of the mth group; \vec{Cgₘₖ} represents a vector of the group center in the kth cluster of the data groups of the mth group; g_{m,k}_{_{b}} represents the bth sample in the kth cluster of the data groups of the mth group; Sₘₖₛ represents sth section in the kth cluster of the data groups of the mth group, and s is one of 1, 2 and 3.

In some embodiments, the keep important samples operation further includes calculating a cosine distance between two samples of the sth section in the kth cluster of the data groups of the mth group. The cosine distance between the two samples of the sth section in the kth cluster of the data groups of the mth group is calculated as follows:

$${D}_{{cos θ}_{{S}_{{mks}_{ef}}}} = {D}_{cos θ} ( \vec{{S}_{mk {s}_{e}}} , \vec{{S}_{m k {s}_{f}}} ) ;$$

where \vec{Sₘₖₛ_{ₑ}} represents a vector of eth sample of the sth section in the kth cluster of the data groups of the mth group; {right arrow over (Sₘₖₛ_{_{f}} )} represents a vector of fth sample of the sth section in the kth cluster of the data groups of the mth group, and e and f are different from each other.

In some embodiments, the keep important samples operation further includes confirming whether a sample number of the sth section in the kth cluster of the data groups of the mth group is greater than a predetermined sample number to generate a confirmation result, and then deciding to execute an important sample selecting operation or an important sample obtaining operation according to the confirmation result. In response to determining that the confirmation result is yes, performing the important sample selecting operation, the important sample obtaining operation and an all sample checking operation in sequence. In response to determining that the confirmation result is no, performing the important sample obtaining operation and the all sample checking operation in sequence. The important sample selecting operation includes selecting three samples with a largest cosine distance in the sth section of the kth cluster of the data groups of the mth group, and moving the three samples into an important sample set. The important sample obtaining operation includes obtaining the important samples of the important sample set. The all sample checking operation includes confirming whether all samples are checked.

In some embodiments, the transfer learning step of the calculating operation further includes regarding the another actual metrology value as a new sample, and calculating a cosine distance between the new sample and the group center in the kth cluster of the data groups of the mth group, and performing the assignment sample operation according to the cosine distance between the new sample and the group center in the kth cluster of the data groups of the mth group, and confirming whether the new sample becomes another important sample.

In some embodiments, the predicting step includes calculating the phase-one virtual metrology value by the another set of process data according to the virtual metrology model based on convolutional autoencoder with keep important samples, and the transfer learning step further includes calculating the phase-two virtual metrology value by the another set of process data and the another actual metrology value according to the virtual metrology model based on convolutional autoencoder with keep important samples. The virtual metrology model based on convolutional autoencoder with keep important samples controls the production tool to process the workpieces. The production tool is corresponding to each of the phase-one virtual metrology value generated in the predicting step and the phase-two virtual metrology value generated in the transfer learning step, and the production tool adopts a dry etching process of semiconductor manufacturing.

### BRIEF DESCRIPTION OF THE DRAWINGS

The present disclosure can be more fully understood by reading the following detailed description of the embodiment, with reference made to the accompanying drawings as follows:

FIG. 1 shows a schematic block diagram of a virtual metrology system based on keep important samples (KIS) and convolutional neural network (CNN) according to a first embodiment of the present disclosure.

FIG. 2 shows a flow chart of a virtual metrology method based on KIS and CNN according to a second embodiment of the present disclosure.

FIG. 3 shows a flow chart of a modeling operation of the virtual metrology method based on KIS and CNN of FIG. 2.

FIG. 4 shows a schematic diagram of networks of convolutional autoencoder of FIG. 2.

FIG. 5 shows a schematic diagram of a keep important samples operation of the present disclosure.

FIG. 6 shows a flow chart of keeping important samples for all sections in each group of FIG. 3.

FIG. 7A shows a flow chart of a dual-phase scheme based on transfer learning with KIS of a calculating operation of FIG. 2.

FIG. 7B shows a flow chart of an online KIS scheme of FIG. 7A.

FIG. 8 shows prediction results of the application example regarding modeling set and testing set of different prediction algorithms of the present disclosure.

FIG. 9A shows a schematic diagram of depth values of the application example regarding modeling set status change in a dry etching process of different prediction algorithms of the present disclosure.

FIG. 9B shows a schematic diagram of cosine distances between sample ID 274 and other sample IDs of FIG. 9A.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected to” another element, it can be directly connected to the other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

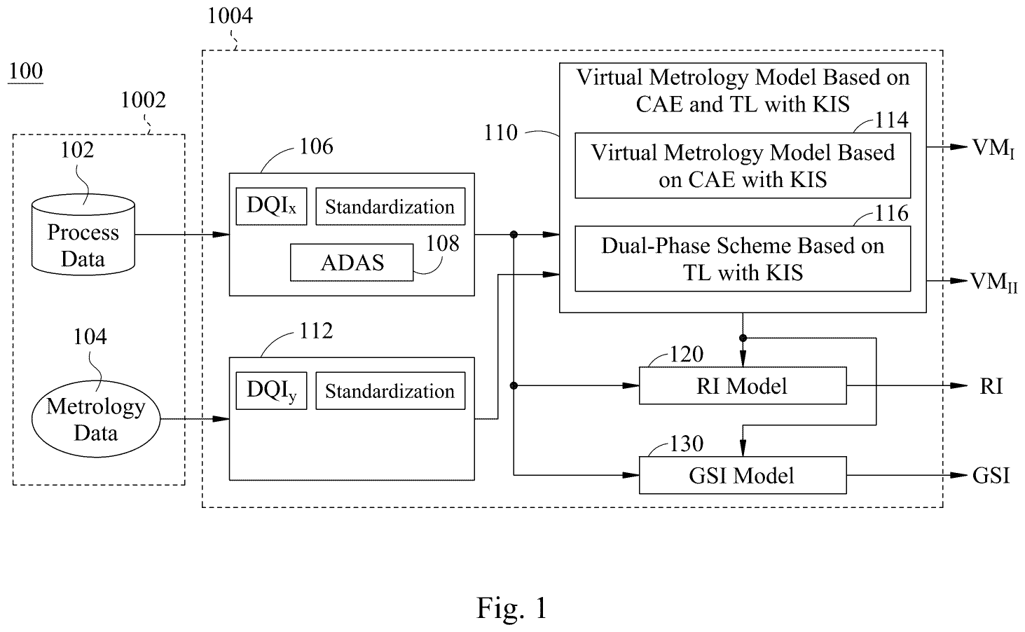

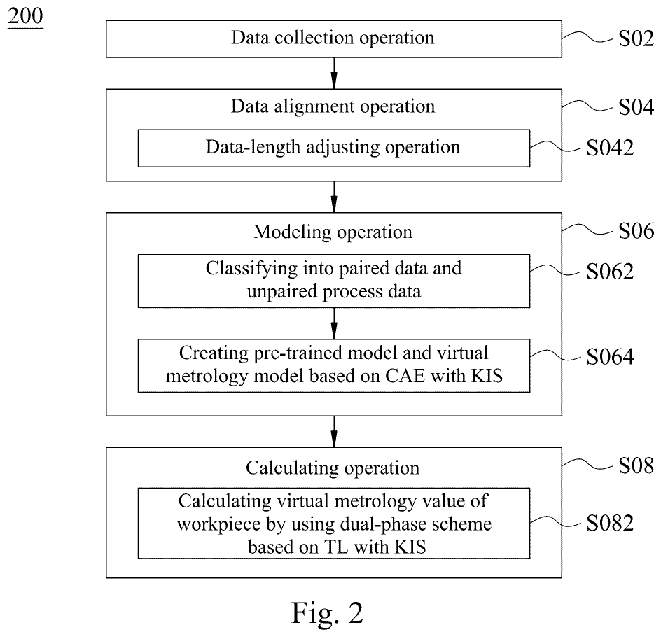

Reference is made to FIGS. 1 and 2. FIG. 1 shows a schematic block diagram of a virtual metrology system 100 based on keep important samples (KIS) and convolutional neural network (CNN) according to a first embodiment of the present disclosure. FIG. 2 shows a flow chart of a virtual metrology method 200 based on KIS and CNN according to a second embodiment of the present disclosure. The virtual metrology system 100 based on KIS and CNN includes a memory 1002 and a processor 1004.

The memory 1002 is configured to store plural sets of process data 102 and plural metrology data 104 (i.e., plural actual metrology values). The sets of process data 102 are used or generated by a production tool when plural workpieces are processed by the production tool, and the sets of process data 102 are one-to-one corresponding to the workpieces. Each of the sets of process data 102 includes values of plural parameters. The values of each of the parameters are respectively corresponding to plural sets of time series data of the workpieces, and each of the sets of time series data has a data length. In other words, the aforementioned plural sets of process data 102 of historical workpieces are obtained by the memory 1002 from the production tool. In addition, each of the metrology data 104 (i.e., the actual metrology values) is obtained after one of the quality items of each workpiece is measured by a metrology tool. For a wafer manufacturing process (e.g., semiconductor manufacturing), the production tool is a wafer processing tool, such as an etch tool, a deposition tool, or a sputter tool, etc.; the actual metrology value (quality item) is a film thickness, an etch depth, an etched sidewall angle, or a critical dimension (CD), etc.; the process data 102 include temperatures. For a wafer sawing process, the production tool is a wafer cutting tool; the actual metrology value (quality item) is a wafer-chipping amount; and the process data 102 include blade clogging, a coolant flow rate, a spindle speed (RPM), a feeding rate, wafer conditions (such as thickness, coating, etc.), and/or a kerf width. For the tool processing, the production tool is a machine tool; the actual metrology value(s) (quality item(s)) include(s) roughness, straightness, angularity, perpendicularity, parallelism and/or roundness; and the process data 102 include a working current, and/or vibration data and/or audio frequency data obtained by three-axis accelerometer sensors or acoustic sensors mounted on the machine tool.

The processor 1004 is electrically connected to the memory 1002. The processor 1004 receives the sets of process data 102 and the metrology data 104 (i.e., the actual metrology values), and is configured to perform a virtual metrology method 200 based on KIS and CNN. In detail, the processor 1004 includes a process data preprocessing operation 106, a virtual metrology model 110 based on convolutional autoencoder (CAE) and transfer learning (TL) with KIS, a metrology data preprocessing operation 112, a reliance index (RI) model 120 and a global similarity index (GSI) model 130. The process data preprocessing operation 106 receives the sets of process data 102. The process data preprocessing operation 106 performs a data alignment operation based on an automated data alignment scheme (ADAS) 108 on the sets of process data 102, thereby deleting the sets of process data 102 of which the temporal distribution profiles are not similar to each other, and enabling the data lengths of the sets of process data 102 to be the same. Before or after the data alignment operation, the process data preprocessing operation 106 may perform data quality evaluation on the sets of process data 102 based on a process data quality index (DQIx) model, and arranges and standardizes (z-score) the original process data 102 from the production tool. The metrology data preprocessing operation 112 performs data quality evaluation on the metrology data 104 (i.e., the aforementioned actual metrology values) of the historical workpieces based on a metrology data quality index (DQI_{y}) model to delete the abnormal values therein, and standardizes the metrology data 104. Then, the metrology data 104 and the aligned process data 102 of the historical workpieces are used as a set of model-building samples for building the virtual metrology model 110 based on CAE and TL with KIS, the RI model 120, and the GSI model 130 according to a convolutional neural network algorithm and a KIS Scheme.

The virtual metrology model 110 based on CAE and TL with KIS includes a virtual metrology model 114 based on CAE with KIS and a dual-phase scheme 116 based on TL with KIS. After the virtual metrology model 110 based on CAE and TL with KIS, the RI model 120, and the GSI model 130 are built, the virtual metrology model 114 based on CAE with KIS is generated, and then virtual metrology may be performed on subsequent workpieces according to the dual-phase scheme 116 based on TL with KIS. The virtual metrology model 114 based on CAE with KIS controls the production tool to process the workpieces. The dual-phase scheme 116 based on TL with KIS includes executing a predicting step (Phase-I) and a transfer learning step (Phase-II). In the predicting step (Phase-I), after a set of process data 102 of a workpiece is obtained, the process data preprocessing operation 106 performs the data alignment operation based on the automated data alignment scheme (ADAS) 108 on the set of process data 102 of the workpiece and/or other data preprocesses. Thereafter, the treated process data 102 are inputted into the virtual metrology model 110 based on CAE and TL with KIS, the RI model 120, and the GSI model 130, thus calculating a phase-one virtual metrology value (VM_{I}) of the workpiece and its RI value and GSI value. In the transfer learning step (Phase-II), after the workpiece has been processed by the production tool, if a quality item of the workpiece is measured by the metrology tool and its metrology data 104 (i.e., an actual metrology value) is obtained, then the process data 102 and the metrology data 104 of the workpiece can be used to retrain or tune (adjust) the virtual metrology model 110 based on CAE and TL with KIS, the RI model 120 and the GSI model 130, thus calculating a phase-two virtual metrology value (VM_{II}) of the workpiece and its RI value and GSI value.

The abovementioned RI model 120, the GSI model 130, the DQIx model and the DQI_{y} model may refer to U.S. Pat. No. 8,095,484 B2. U.S. Pat. No. 8,095,484 B2 is hereby incorporated by reference. In addition, the memory 1002 may include a random access memory (RAM) or another type of dynamic storage device that may store information and instructions for execution by the processor 1004. The processor 1004 may include any type of processor, microprocessor, or processing logic that may interpret and execute instructions (e.g., a field programmable gate array (FPGA)). The processor 1004 may include a single device (e.g., a single core) and/or a group of devices (e.g., multi-core).

Therefore, the virtual metrology system 100 based on KIS and CNN of the present disclosure utilizes a downsampling-based KIS scheme based on CAE, K-means, and cosine distance. The KIS scheme aims to balance the retention of the important samples within each value range for effectively resolving the imbalance problem and enhancing the model's learning effectiveness during fine-tuning, which facilitates advanced automatic virtual metrology to have wider application in the more and more sophisticated semiconductor industry.

In FIG. 2, the virtual metrology method 200 based on KIS and CNN includes plural steps S02, S04, S06 and S08. The step S02 includes performing a data collection operation to obtain plural sets of process data 102, in which the sets of process data 102 are used or generated by a production tool when plural workpieces are processed by the production tool, and the sets of process data 102 are one-to-one corresponding to the workpieces. Each of the sets of process data 102 includes values of plural parameters, and values of each of the parameters are respectively corresponding to plural sets of time series data of the workpieces. Each of the sets of time series data has a data length.

The step S04 includes performing a data alignment operation onto the sets of process data 102. The data alignment operation includes performing a frequency distribution calculation with respect to the data length of each of the sets of time series data of each of the parameters, thereby obtaining a distribution of appearance frequencies versus data lengths. The data length with the largest appearance frequency in the sets of time series data of each of the parameters is a reference data length. Thereafter, an operation of obtaining a set of reference time series data is performed, in which a mean calculation is performed on the sets of time series data with the reference data length in the sets of time series data of each of the parameters, thereby obtaining a set of reference time series data of each of the parameters. After the set of reference time series data of each of the parameters is obtained, an operation of calculating data distances is performed, in which a distance between each of the sets of time series data of each of the parameters and its corresponding reference time series data is calculated by using a dynamic time warping (DTW) algorithm. The DTW calculates the similarity between two sets of time series data by extending and/or shortening the time series, and it is widely adopted for speech recognition and language recognition to distinguish whether two sets of voice data represents the same word. Thereafter, an operation of setting a distance threshold is performed. When the distance (data distance) between a set of time series data of a parameter of a workpiece and its corresponding reference time series data is greater than the distance threshold, an operation of deleting the set of (historical) process data 102 (time series data) corresponding to the distance is performed, i.e., the set of process data 102 is not similar to other set of process data 102, and is not suitable for model building. Next, an operation of setting an upper limit of data length is performed. Thereafter, a step S042 is performed and includes performing a data-length adjusting operation to repeat adding at least one data point having a value of an end data point of each of the sets of time series data of each of the parameters after the end data point until the data length of each of the sets of time series data of each of the parameters is equal to a longest data length of the sets of process data 102.

After the data-length adjusting operation (i.e., the step S042) is performed, plural metrology data 104 (i.e., plural actual metrology values) of the workpieces are obtained, and then the step S06 is performed. The step S06 includes performing a modeling operation, and the modeling operation includes performing steps S062 and S064. The step S062 includes classifying the sets of process data 102 and the actual metrology values into plural paired data and at least one unpaired process data, in which each of the paired data includes one of the sets of process data 102 and one of the actual metrology values corresponding to the one of the sets of process data 102. The step S064 includes creating at least one pre-trained model by using the at least one unpaired process data, and performing a keep important samples operation on the paired data to generate a plurality of important samples, and then inputting the important samples to the at least one pre-trained model to create a virtual metrology model based on convolutional autoencoder (CAE) with keep important samples (KIS). The virtual metrology model based on CAE with KIS includes at least one convolutional neural network model. The number of the important samples is smaller than the number of the paired data.

The step S08 includes performing a calculating operation (a testing operation), and the calculating operation includes performing a step S082. The step S082 includes obtaining at least one of another set of process data 102 and another actual metrology value of another workpiece, and executing one of a predicting step (Phase-I) and a transfer learning step (Phase-II) according to whether the another actual metrology value is obtained, thereby calculating one of a phase-one virtual metrology value (VM_{I}) and a phase-two virtual metrology value (VM_{II}) of the another workpiece. The transfer learning step (Phase-II) includes performing calculations according to the virtual metrology model 114 based on CAE with KIS. The predicting step (Phase-I) includes calculating the phase-one virtual metrology value (VM_{I}) by the another set of process data 102 according to the virtual metrology model 114 based on CAE with KIS, and the transfer learning step (Phase-II) includes calculating the phase-two virtual metrology value (VM_{II}) of the another workpiece by the another set of process data 102 and the another actual metrology value according to the virtual metrology model 114 based on CAE with KIS. The dual-phase scheme 116 based on TL with KIS of the present disclosure is realized by the predicting step (Phase-I) and the transfer learning step (Phase-II). The detail of the modeling operation of the step S06 and the calculating operation of the step S08 is described as follows.

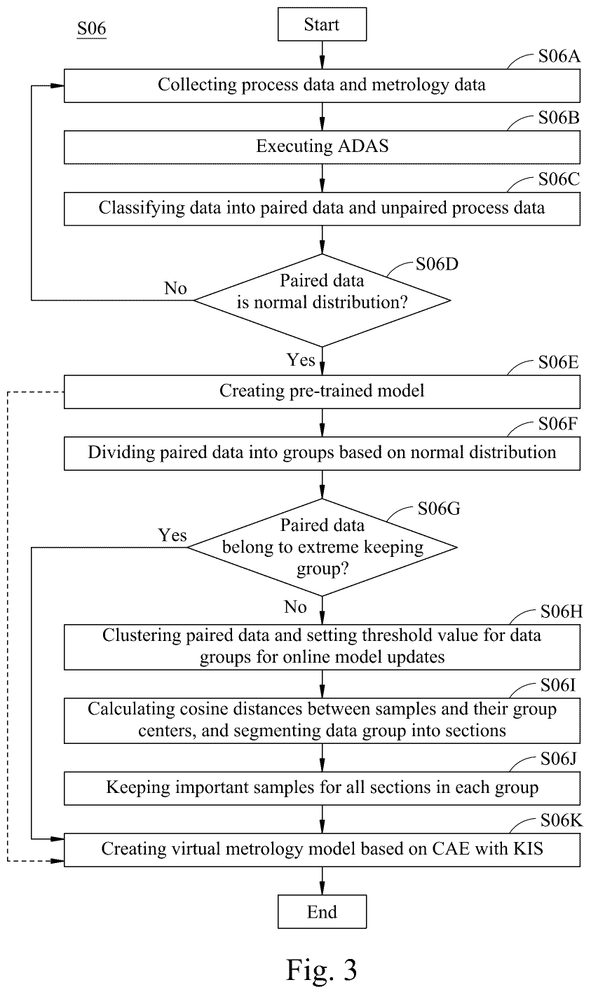

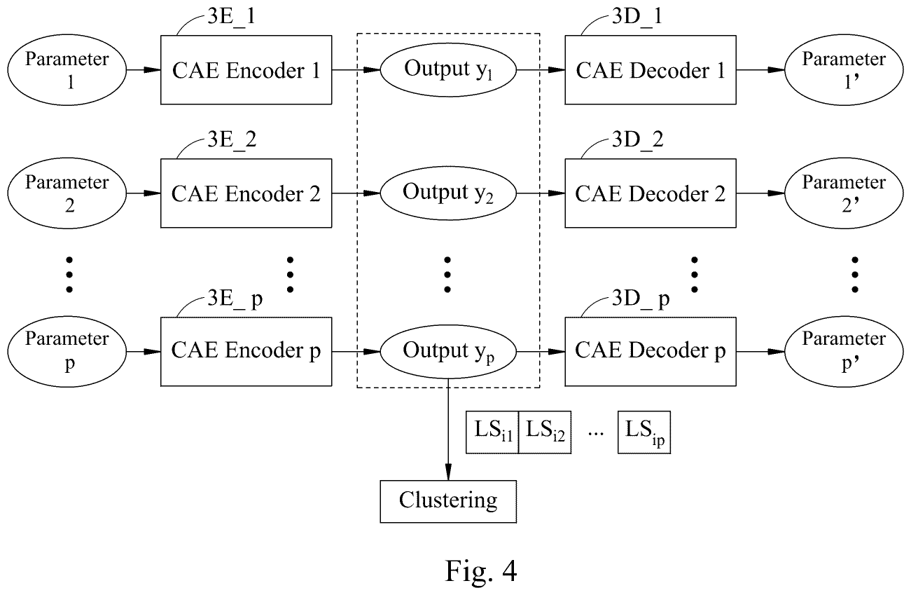

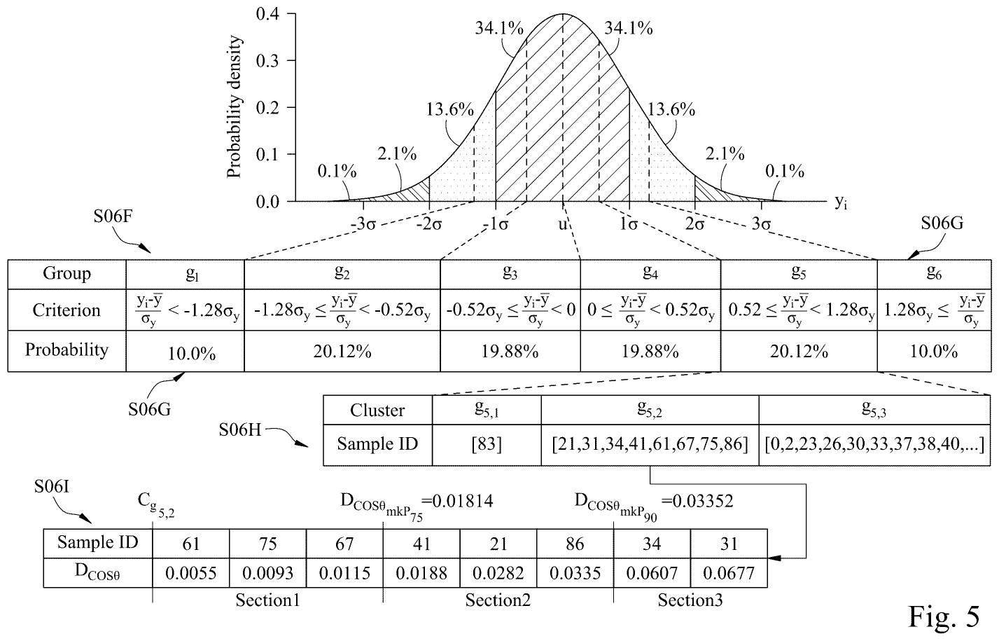

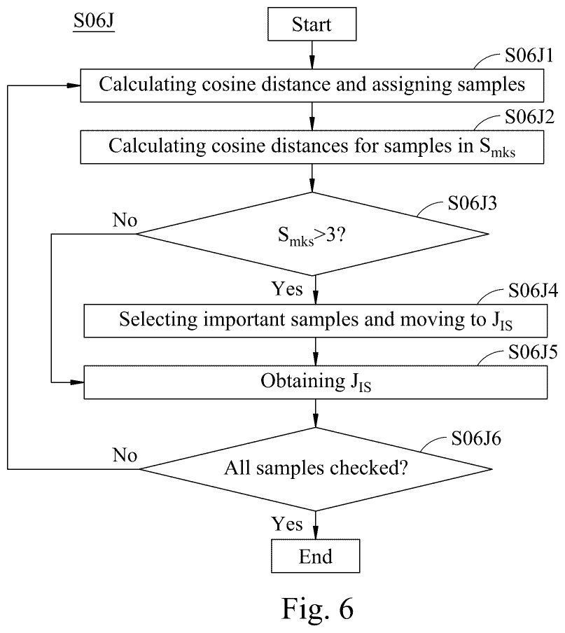

Reference is made to FIGS. 1, 2, 3, 4, 5 and 6. FIG. 3 shows a flow chart of a modeling operation (the step S06) of the virtual metrology method 200 based on KIS and CNN of FIG. 2. FIG. 4 shows a schematic diagram of networks of CAE of FIG. 2. FIG. 5 shows a schematic diagram of a keep important samples operation (steps S06F, S06G, S06H, S06I) of the present disclosure. FIG. 6 shows a flow chart of keeping important samples for all sections in each group (step S06J) of FIG. 3. The keep important samples operation of the step S06 includes judging that each of the paired data belongs to one of an extreme keeping group and a selective keeping group according to a distribution of the paired data, and performing downsampling on a part of the paired data belonging to the selective keeping group to obtain a plurality of keeping data. The important samples include another part of the paired data belonging to the extreme keeping group and the keeping data. The step S06 includes performing steps S06A, S06B, S06C, S06D, S06E, S06F, S06G, S06H, S06I, S06J and S06K.

The step S06A includes collecting plural sets of process data 102 of the historical workpieces and the metrology data 104 (i.e., the actual metrology values). The step S06B includes performing a data alignment operation based on an automated data alignment scheme (ADAS) 108 on the sets of process data 102, thereby deleting the sets of process data 102 of which the temporal distribution profiles are not similar to each other, and enabling the data lengths of the sets of process data 102 to be the same. The step S06C includes classifying the sets of process data 102 and the actual metrology values into plural paired data and at least one unpaired process data, in which each of the paired data includes one of the sets of process data 102 and one of the actual metrology values corresponding to the one of the sets of process data 102.

The step S06D includes confirming whether the paired data is a normal distribution to generate a distribution confirmation result. When the distribution confirmation result is yes (i.e., the distribution of the paired data is the normal distribution), performing the step S06E. When the distribution confirmation result is no, performing the step S06A again.

The step S06E includes creating at least one pre-trained model by using the at least one unpaired process data. In the step S06E, the at least one unpaired process data is used to create the at least one pre-trained model. The at least one pre-trained model is formed by a network of CAE, as shown in FIG. 4. The at least one pre-trained model includes plural CAE encoders 3E_1, 3E_2 and 3E_p, and plural CAE decoders 3D_1, 3D_2 and 3D_p. The CAE encoders 3E_1, 3E_2 and 3E_p receive a parameter 1, a parameter 2 and a parameter p, respectively. The CAE encoders 3E_1, 3E_2 and 3E_p generate an output y₁, an output y₂ and an output yₚ, respectively. The CAE decoders 3D_1, 3D_2 and 3D_p receive the output y₁, the output y₂ and the output yₚ, respectively. The CAE decoders 3D_1, 3D_2 and 3D_p generate a parameter 1′, a parameter 2′ and a parameter p′, respectively. The number of the at least one convolutional neural network model is plural. The CAE algorithm can be used to extract features LSᵢ₁, LSᵢ₂, . . . , LSᵢₚ, and the features LSᵢ₁, LSᵢ₂, . . . , LSᵢₚ correspond to outputs of the convolutional neural network models (i.e., the output yᵢ, the output y₂, . . . , the output yₚ). In addition, the virtual metrology model 114 based on CAE with KIS includes the convolutional neural network models (e.g., the CAE encoders 3E_1, 3E_2 and 3E_p) and a conjecture model. The convolutional neural network models include plural inputs (i.e., the parameter 1, the parameter 2, . . . , the parameter p) and plural outputs (i.e., the output yᵢ, the output y₂, . . . , the output yₚ). The inputs of the convolutional neural network models are the paired data, respectively, and the outputs of the convolutional neural network models are inputs of the conjecture model. The convolutional neural network models typically include a convolutional layer, a pooling layer, a flatten layer, a dropout layer and a fully-connected neural network, in which the fully-connected neural network includes at least one hidden layer and an output layer. The conjecture model has the same structure as the fully-connected neural network. The abovementioned convolutional neural network models and the conjecture model can refer to U.S. Pat. Pub. No. 2023/0419107 A1. That is, U.S. Pat. Pub. No. 2023/0419107 A1 is hereby incorporated by reference.

The step S06F includes dividing the paired data into plural groups based on the normal distribution. In detail, the step S06F includes dividing the normal distribution into six groups according to a judgment condition. The six groups include a first group g₁, a second group g₂, a third group g₃, a fourth group g₄, a fifth group g₅ and a sixth group g₆, as shown in FIG. 5. The first group g₁ and the sixth group g₆ belong to the extreme keeping group. The second group g₂, the third group g₃, the fourth group g₄ and the fifth group g₅ belong to the selective keeping group. In other words, the step S06F includes dividing the normal distribution into the extreme keeping group and the selective keeping group according to the judgment condition, and dividing the paired data into the part of the paired data and the another part of the paired data according to the extreme keeping group and the selective keeping group. The judgment condition (criterion) is calculated as follows:

$$\frac{y i - \overline{y}}{{σ}_{y}} < - p {σ}_{y} ; \qquad ( 1 )$$

$$- p {σ}_{y} \leq \frac{{y}_{i} - \overline{y}}{{σ}_{y}} < - q {σ}_{y} ; \qquad ( 2 )$$

$$- q {σ}_{y} \leq \frac{{y}_{i} - \overline{y}}{{σ}_{y}} < 0 ; \qquad ( 3 )$$

$$0 \leq \frac{{y}_{i} - \overline{y}}{{σ}_{y}} < q {σ}_{y} ; \qquad ( 4 )$$

$$q {σ}_{y} \leq \frac{{y}_{i} - \overline{y}}{{σ}_{y}} < p {σ}_{y} ; \qquad ( 5 )$$

$$p {σ}_{y} \leq \frac{{y}_{i} - \overline{y}}{{σ}_{y}} ; \qquad ( 6 )$$

where p represents a parameter which is greater than 1 and smaller than or equal to 2; q represents another parameter which is greater than 0 and smaller than or equal to 1. In the embodiment, the parameters p and q are equal to 1.28 and 0.52, respectively, but the present disclosure is not limited thereto. yᵢ represents ith actual metrology value; y̅ represents an average value (u) of yᵢ; σ_{y} represents a standard deviation (σ) of yᵢ. y̅ and σ_{y} are calculated as follows:

$$\overline{y} = \frac{{\sum }_{i = 1}^{n} {y}_{i}}{n} ; \qquad ( 7 )$$

$${o}_{y} = \sqrt{\frac{{( {y}_{i} - \overline{y} )}^{2}}{( n - 1 )}} ; \qquad ( 8 )$$

where n represents a sample size of yᵢ. In the normal distribution, the part of the paired data that meets the judgment condition belongs to the extreme keeping group, and the another part of the paired data that does not meet the judgment condition belongs to the selective keeping group. The judgment conditions of the first group g₁, the second group g₂, the third group g₃, the fourth group g₄, the fifth group g₅ and the sixth group g₆ respectively correspond to equations (1), (2), (3), (4), (5) and (6). The probabilities of the first group g₁, the second group g₂, the third group g₃, the fourth group g₄, the fifth group g₅ and the sixth group g₆ respectively correspond to 10.00%, 20.12%, 19.88%, 19.88%, 20.12% and 10.00%.

The step S06G includes judging whether the paired data belong to the extreme keeping group. In detail, the step S06G includes judging whether each of the paired data belongs to the extreme keeping group (i.e., belongs to the first group g₁ and the sixth group g₆) according to the six groups divided from the normal distribution to generate a group judgment result. When the group judgment result is yes, performing the step S06K. When the group judgment result is no, performing the step S06H.

The step S06H includes clustering the paired data and setting threshold value for data groups for online model updates. In detail, the step S06H includes clustering the another part of the paired data (corresponding to the features LSᵢ₁, LSᵢ₂, . . . , LSᵢₚ in FIG. 4) into a plurality of data groups (clusters) according to a grouping algorithm, and setting a threshold value for the data groups, and calculating a group center and two percentage parameters

$$( e . g . , {D}_{cos {θ}_{{mkP}_{75}}} , {D}_{cos {θ}_{{mkP}_{90}}} )$$

of each of the data groups according to the threshold value. The threshold value is represented by

$${D}_{cos {θ}_{{mk}_{T}}}$$

and calculated as follows:

$${D}_{co s {θ}_{{mk}_{T}}} = {\overline{{D}_{c os θ}}}_{mk} + α \times {σ}_{{D}_{co s {θ}_{mk}}} ; \qquad ( 9 )$$

$${\overline{{D}_{co s θ}}}_{mk} = \frac{{\sum }_{c = 1}^{b} {\sum }_{d = c + 1}^{q} {D}_{co s {θ}_{mkcb}}}{( q \times \frac{q - 1}{2} )} ; \qquad ( 10 )$$

$${σ}_{{D}_{co s {θ}_{mk}}} = \sqrt{\frac{{( ( {\sum }_{c = 1}^{b} {\sum }_{b = c + 1}^{q} {D}_{co s {θ}_{{mk}_{cb}}} ) - {\overline{{D}_{co s θ}}}_{mk} )}^{2}}{( q \times \frac{q - 1}{2} )}} ; \qquad ( 11 )$$

where [symbol] represents an average value of a cosine distance between two samples in kth cluster of the data groups of mth group;

$${σ}_{{D}_{cos {θ}_{mk}}}$$

represents a standard deviation of the cosine distance between the two samples in the kth cluster of the data groups of the mth group;

$${D}_{cos {θ}_{{mk}_{cb}}}$$

represents a cosine distance between a vector of bth sample and a vector of cth sample in the kth cluster of the data groups of the mth group; a represents a threshold setting factor; b and c belong to q and are different from each other; and q represents a sample number of the mth group. In the embodiment, the grouping algorithm may be a K-means algorithm, but the present disclosure is not limited thereto.

The step S06I includes calculating cosine distances between samples and their group centers, and segmenting the data group into sections. In detail, the step S06I includes segmenting one (e.g., g_{5,2}) of the data groups into a plurality of sections (e.g., Section1-Section2-Section3) according to the group center (e.g., C_{g}_{_{5,2}}) and the two percentage parameters

$$( e . g . , {D}_{cos {θ}_{{mkP}_{75}}} , {D}_{cos {θ}_{{mkP}_{90}}} ) .$$

The step S06J includes keeping important samples for all sections in each group. In other words, the step S06J includes selecting the most representative sample of each segment and keeping it as an important sample, thereby keeping most amount of data in each group. In FIG. 6, the step S06J includes performing steps S06J1, S06J2, S06J3, S06J4, S06J5 and S06J6.

The step S06J1 includes calculating cosine distance and assigning samples. In detail, the step S06J1 includes calculating a cosine distance between a sample in the one of the data groups and the group center, and performing an assignment sample operation according to the cosine distance between the sample in the one of the data groups and the group center. The assignment sample operation is performed as follows:

$$\{ \begin{matrix}if {C}_{{g}_{m , k}} \leq {D}_{co s θ} ( \vec{{g}_{{mk}_{b}}} , \vec{{Cg}_{mk}} ) \leq {D}_{co s {θ}_{{mkP}_{75}}} , {g}_{m , {k}_{b}} ∈ {S}_{mk 1} \\ if {D}_{co s {θ}_{{mkP}_{75}}} \leq {D}_{co s θ} ( \vec{{g}_{{mk}_{b}}} , \vec{{Cg}_{mk}} ) \leq {D}_{co s {θ}_{{mkP}_{90}}} , {g}_{m , {k}_{b}} ∈ {S}_{mk 2} \\ otherwise , {g}_{m , {k}_{b}} ∈ {S}_{mk 3}\end{matrix} ; \qquad ( 12 )$$

where C_{g}_{_{m,k}} represents the group center; D_{cos θ}(gₘₖ_{_{b}}, Cgₘₖ) represents the cosine distance between the sample in the one of the data groups and the group center;

$${D}_{cos {θ}_{{mkP}_{75}}} and {D}_{cos {θ}_{{mkP}_{90}}}$$

represent the two percentage parameters; {right arrow over (gₘₖ_{_{b}} )} represents a vector of bth sample in the kth cluster of the data groups of the mth group; \vec{Cgₘₖ} represents a vector of the group center in the kth cluster of the data groups of the mth group; g_{m,k}_{_{b}} represents the bth sample in the kth cluster of the data groups of the mth group, and has a sample ID; Sₘₖₛ represents sth section in the kth cluster of the data groups of the mth group, and s is one of 1, 2 and 3.

The step S06J2 includes calculating cosine distances for samples in Sₘₖₛ. In detail, the step S06J2 includes calculating a cosine distance

$$( {D}_{cos {θ}_{{S}_{{mks}_{ef}}}} )$$

between two samples (Sₘₖₛ_{ₑ}, Sₘₖₛ_{_{f}}) of the sth section (Sₘₖₛ) in the kth cluster of the data groups of the mth group. The cosine distance between the two samples of the sth section in the kth cluster of the data groups of the mth group is calculated as follows:

$${D}_{co s {θ}_{{S}_{{mks}_{ef}}}} = {D}_{co s θ} ( \vec{{S}_{{mks}_{e}}} , \vec{{S}_{{mks}_{f}}} ) ; \qquad ( 13 )$$

where \vec{Sₘₖₛ_{ₑ}} represents a vector of eth sample of the sth section in the kth cluster of the data groups of the mth group; {right arrow over (Sₘₖₛ_{_{f}} )} represents a vector of fth sample of the sth section in the kth cluster of the data groups of the mth group, and e and f are different from each other. The eth sample and the fth sample are the two samples (Sₘₖₛ_{ₑ}, Sₘₖₛ_{_{f}}), respectively.

The step S06J3 includes confirming a sample number of the sth section Sₘₖₛ. In detail, the step S06J3 includes confirming whether a sample number of the sth section (Sₘₖₛ) in the kth cluster of the data groups of the mth group is greater than a predetermined sample number to generate a confirmation result, and then deciding to execute an important sample selecting operation (the step S06J4) or an important sample obtaining operation (the step S06J5) according to the confirmation result. In response to determining that the confirmation result is yes, performing the important sample selecting operation (the step S06J4), the important sample obtaining operation (the step S06J5) and an all sample checking operation (the step S06J6) in sequence. In response to determining that the confirmation result is no, performing the important sample obtaining operation (the step S06J5) and the all sample checking operation (the step S06J6) in sequence. In the embodiment, the predetermined sample number may be 3, but the present disclosure is not limited thereto.

The step S06J4 includes performing the important sample selecting operation. The important sample selecting operation includes selecting three samples with a largest cosine distance

$$( {D}_{cos {θ}_{{S}_{{mks}_{ef}}}} )$$

in the sth section (Smks) of the kth cluster of the data groups of the mth group, and moving the three samples into an important sample set (J_{IS}). The step S06J5 includes performing the important sample obtaining operation. The important sample obtaining operation includes obtaining the important samples of the important sample set.

The step S06J6 includes performing the all sample checking operation. The all sample checking operation includes confirming whether all samples are checked. When the result of the step S06J6 is yes, the step S06 is ended. When the result of the step S06J6 is no, reperforming the step S06J1.

The step S06K includes inputting the important samples to the at least one pre-trained model to create the virtual metrology model 114 based on CAE with KIS. The virtual metrology model 114 based on CAE with KIS includes at least one convolutional neural network model.

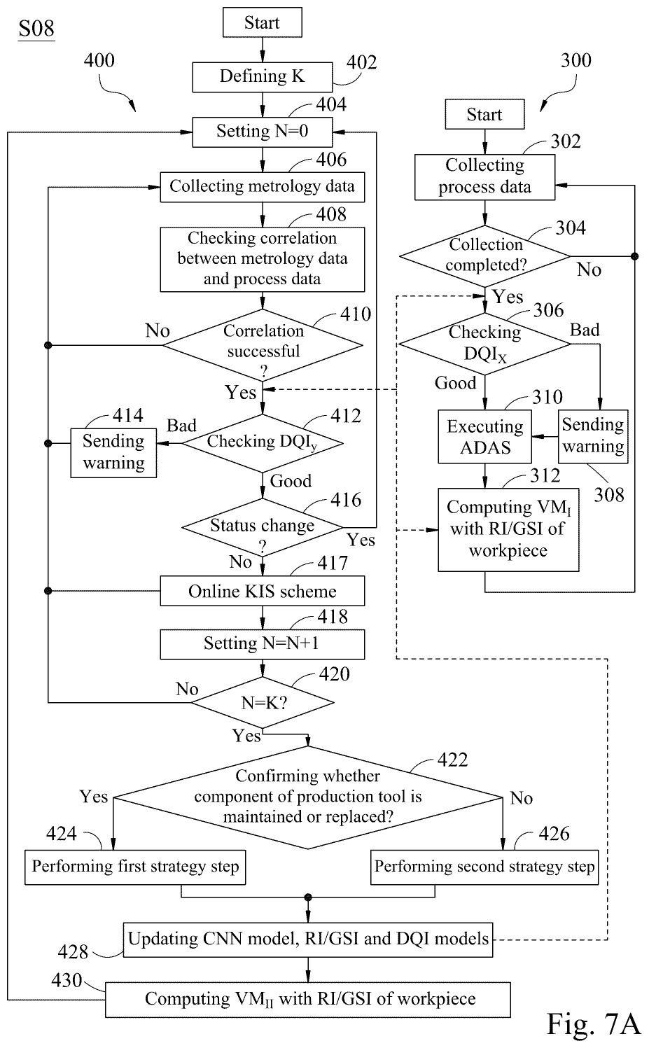

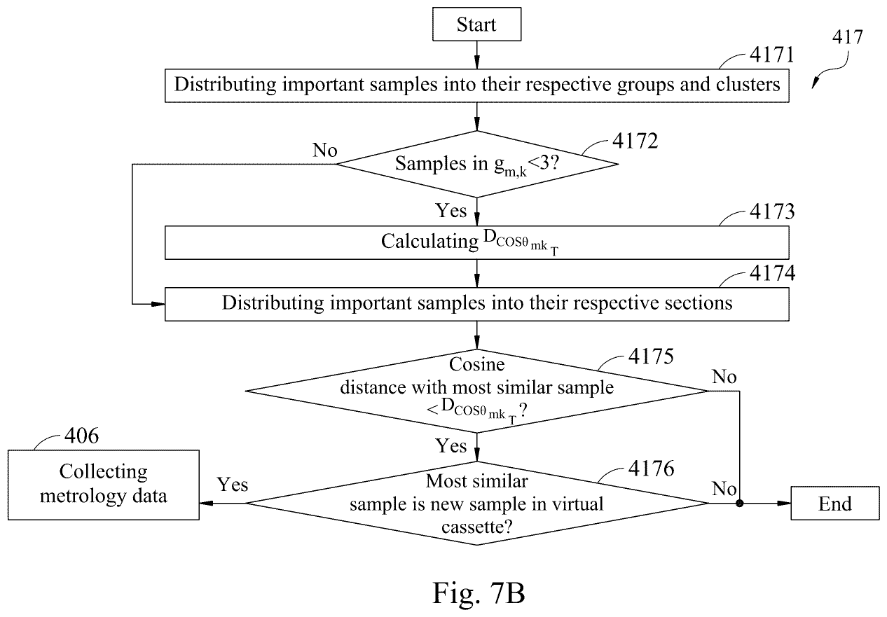

Reference is made to FIGS. 1, 2, 3, 4, 5, 6, 7A and 7B. FIG. 7A shows a flow chart of a dual-phase scheme 116 based on transfer learning (TL) with KIS of a calculating operation (the step S08) of FIG. 2. FIG. 7B shows a flow chart of an online KIS scheme (step 417) of FIG. 7A. In the calculating operation, when the another actual metrology value is not obtained, performing the predicting step 300 to calculate the phase-one virtual metrology value (VMi) of the another workpiece. When the another actual metrology value is obtained, performing the transfer learning step 400 to calculate the phase-two virtual metrology value (VMii) of the another workpiece.

In the predicting step 300, first, a step 302 is performed to collect the process data 102 of a workpiece sent by a process device. Next, a step 304 is performed to check whether the collection of the process data 102 of the workpiece is completed. If the result of the step 304 is no, the step 302 is performed continually. If the result of the step 304 is yes, a step 306 is performed to evaluate the DQIx of the process data 102. If the result of the step 306 is bad, it represents that the process data 102 is abnormal data, and a warning is sent (a step 308). If the result of the step 306 is good, it represents that the process data 102 is normal data, and a step 310 is performed. The step 310 includes performing a data alignment operation based on an automated data alignment scheme (ADAS) 108 on the sets of process data 102. Finally, a step 312 is performed to input the another set of process data 102 of the another workpiece into the virtual metrology model 114 based on CAE with KIS, thereby calculating the phase-one virtual metrology value (VMi) of the another workpiece after performing the data alignment operation onto the another set of process data 102 of the another workpiece.

In the transfer learning step 400, first, a step 402 is performed to define a predetermined parameter value K. Strategy selection may be periodically confirmed according to predetermined parameter value K (i.e., a strategy selection confirming step 422 is periodically performed), and the predetermined parameter value K is a positive integer. Next, a step 404 is performed to set an initial value of a count parameter value N to 0, and the count parameter value N is an integer. Then, a step 406 is performed to collect the actual metrology data 104 of a certain workpiece. Next, a step 408 is performed to check whether the process data 102 of the certain workpiece corresponding to the actual metrology data 104 exists, i.e., check the correlation between the metrology data 104 and the process data 102. Then, a step 410 is performed to judge whether the correlation check is successful. If the result of the step 410 is no, the step 406 is performed continually. If the result of the step 410 is yes, a step 412 is performed to evaluate the DQly to judge whether the actual metrology data 104 is normal. If the result of the step 412 is bad, a warning is sent (a step 414), and the step 406 is performed continually. If the result of the step 412 is good, a step 416 is performed to confirm whether a status of the production tool has changed. If the result of the step 416 is yes (i.e., the status of the production tool has changed), the step 404 is performed. If the result of the step 416 is no (i.e., the status of the production tool has not changed), a step 417 is performed to execute an online KIS scheme.

The step 417 includes regarding the another actual metrology value as a new sample, and calculating a cosine distance between the new sample and the group center in the kth cluster of the data groups of the mth group, and performing the assignment sample operation according to the cosine distance between the new sample and the group center in the kth cluster of the data groups of the mth group, and confirming whether the new sample becomes another important sample. Therefore, the present disclosure utilizes the dual-phase algorithm improved by adopting the online KIS scheme. The important samples are selected to achieve real-time model refreshing and avoid the sample-imbalance issue when new samples come in. In addition, since the virtual metrology system 100 based on KIS and CNN is a time-varying system, the dual-phase algorithm possesses the ability of model refreshing to ensure good prediction accuracy. In FIG. 7B, the step 417 includes performing steps 4171, 4172, 4173, 4174, 4175 and 4176.

The step 4171 includes distributing the important samples into their respective groups and clusters. In detail, the step 4171 includes regarding the another actual metrology value as a new sample, and assigning the new sample to the gₘ (the mth group) it belongs according to its actual metrology value, and calculating the features LSₚ of the new sample via the CAE model (the CAE algorithm) within the g_{m,k}. The new sample is furtherly assigned to the g_{m,k} (the kth cluster of the data groups of the mth group) it belongs according to its features LSₚ.

The step 4172 includes confirming whether the sample number in the kth cluster of the data groups of the mth group (g_{m,k}) is less than a predetermined data group sample number or not. When the result of the step 4172 is yes, performing the step 4173. When the result of the step 4172 is no, performing the step 4174. In the embodiment, the predetermined data group sample number may be 3, but the present disclosure is not limited thereto.

The step 4173 includes calculating the threshold value

$${D}_{cos {θ}_{{mk}_{T}}}$$

according to the aforementioned equations (9)-(11). The step 4174 includes distributing the important samples into their respective sections. In detail, the step 4174 includes calculating the cosine distance between the new sample and the group center C_{g}_{_{m,k}}, and assigning the new sample to its corresponding section (Sₘₖₛ) according to the assignment sample operation of the equation (12).

The step 4175 includes confirming whether the cosine distance with most similar sample is small than the threshold value

$${D}_{cos {θ}_{{mk}_{T}}} .$$

In detail, the step 4175 includes calculating the cosine distance between all the old samples in the sth section (Smks) of the kth cluster of the data groups of the mth group and the new sample according to equation (13), and confirming whether the cosine distance is small than the threshold value

$${D}_{cos {θ}_{{mk}_{T}}}$$

to find the most similar sample. When the result of the step 4175 is yes (i.e., the cosine distance is small than the threshold value

$${D}_{cos {θ}_{{mk}_{T}}} ) ,$$

the similar sample replaces the old sample, and then the step 4176 is performed. When the result of the step 4175 is no (i.e., the cosine distance is greater than or equal to the threshold value

$${D}_{cos {θ}_{{mk}_{T}}} ) ,$$

the new sample is regarded as an important sample and is added in the important sample set (i.e., the new sample is added in as an important sample), and then the step 417 is ended.

The step 4176 includes confirming whether the most similar sample is a new sample, i.e., confirming whether the similar sample that replaces the old sample is a new sample. If yes, reperforming the step 406 (collecting the actual metrology data 104); if no, ending the step 417.

Next, a step 418 is performed to set N=N+1. Then, a step 420 is performed to confirm whether the count parameter value N is equal to the predetermined parameter value K. If the result of the step 420 is no, the step 406 is performed continually. If the result of the step 420 is yes, a strategy selection confirming step 422 is performed on the another actual metrology value of the another workpiece to generate a confirmation result, and one of a first strategy step 424 and a second strategy step 426 is performed according to the confirmation result to update the virtual metrology model 114 based on CAE with KIS. The strategy selection confirming step 422 includes confirming whether or not a component of the production tool is maintained or replaced. In response to determining that the confirmation result is that the component of the production tool is maintained or replaced, the first strategy step 424 is performed. In contrast, in response to determining that the confirmation result is that the component of the production tool is not maintained or replaced, the second strategy step 426 is performed.

The first strategy step 424 includes inputting a plurality of sets of time series data of a plurality of parameters of the another set of process data 102 and the another actual metrology value of the another workpiece into the convolutional neural network models; and inputting the outputs of the convolutional neural network models into the conjecture model to update the virtual metrology model 114 based on CAE with KIS. In other words, the convolutional neural network models and the conjecture model are re-freshed (Re-freshing). In addition, the first strategy step 424 further includes retraining the RI model, the GSI model, the DQIx model and the DQly model. “Retraining” represents retraining each of the models using updated historical process data 102 and historical metrology values.

The second strategy step 426 includes inputting the outputs of the convolutional neural network models into the conjecture model to update a part of the virtual metrology model 114 based on CAE with KIS. In other words, the convolutional neural network models are frozen (Freezing) and not re-freshed, and only the conjecture model is re-freshed. In addition, the second strategy step 426 further includes tuning (adjusting) the RI model, the GSI model, the DQIₓ model and the DQI_{y} model. Before performing a retraining step or a tuning step, an oldest one of the historical process data 102 and the historical metrology values is replaced by a latest one of the sets of process data 102 and the actual metrology values obtained at present. “Tuning” represents adjusting weighting value or parameter value of each of the models using the updated historical process data 102 and the historical metrology values. The execution time of the first strategy step 424 is less than the execution time of the second strategy step 426.

After performing one of the first strategy step 424 and the second strategy step 426, a step 428 of updating the model is performed to replace the original virtual metrology models with the tuned or retrained virtual metrology models. The tuned or retrained virtual metrology models include the CNN model, the RI model, the GSI model, the DQIₓ model and the DQI_{y} model. The tuned or retrained virtual metrology models are also provided to the steps 306, 312 and 412 to evaluate the quality (DQIx) of the process data 102 of a next workpiece, and calculate the phase-one virtual metrology value (VM_{I}) of the next workpiece and its RI value and GSI value, and evaluate the quality (DQI_{y}) of the actual metrology data 104 of the next workpiece. Finally, a step 430 is performed to input the another set of process data 102 of the another workpiece into the virtual metrology model 114 based on CAE with KIS (the updated one), thereby calculating the phase-two virtual metrology value (VMii) of the another workpiece.

The abovementioned first strategy step 424 and the second strategy step 426 can refer to U.S. Pat. Pub. No. 2023/0419107 A1. That is, U.S. Pat. Pub. No. 2023/0419107 A1 is hereby incorporated by reference.

Therefore, the virtual metrology method 200 based on KIS and CNN of the present disclosure utilizes the dual-phase algorithm improved by adopting the online KIS scheme. The important samples are selected to achieve real-time model refreshing and avoid the sample-imbalance issue when new samples come in. In addition, in the time-varying system, the dual-phase algorithm improved by adopting the online KIS scheme possesses the ability of model refreshing and improves the learning efficiency of the model during the fine-tuning process to ensure good prediction accuracy.

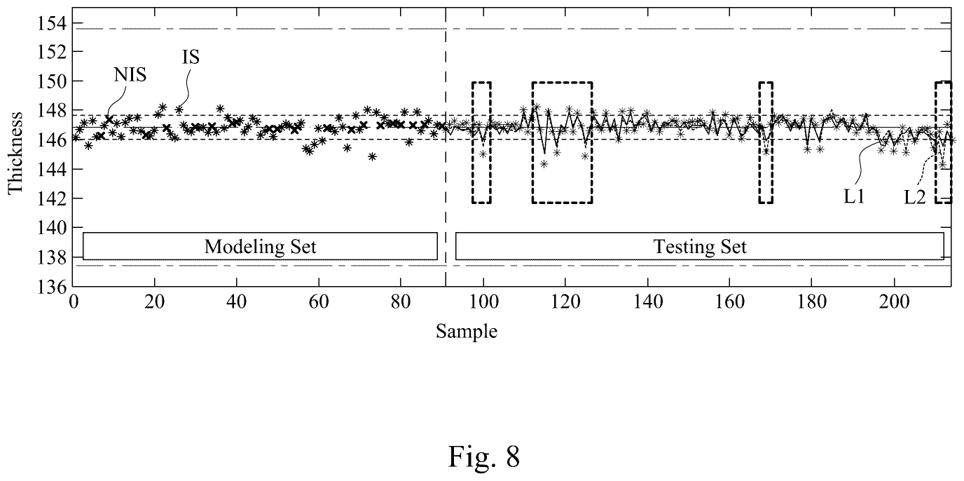

Reference is made to FIGS. 1, 2, 3, 4, 5, 6, 7A, 7B and 8. FIG. 8 shows prediction results of the application example regarding modeling set and testing set of different prediction algorithms of the present disclosure. The application example is applied to a semiconductor dry etching process. In FIG. 8, the horizontal axis represents the sample, and the vertical axis represents the thickness. For the modeling set, there are originally 90 paired data, and 64 paired data are retained as the important samples IS when the offline model creation stage (the modeling operation of the step S06) of FIG. 3 is completed. The unretained paired data are regarded as non-important samples NIS. A curve L1 represents the prediction result of the thickness when using only a virtual metrology method based on CNN (Advanced AVM_{CNN}). A curve L2 represents the prediction result of the thickness when using the virtual metrology method 200 based on KIS and CNN of the present disclosure (Advanced AVM_{CNN} with KIS). Table 1 lists the prediction accuracies and R² values of the thickness of different prediction algorithms, and the prediction accuracies are expressed as mean absolute error (MAE). In FIG. 8 and Table 1, it can be clearly observed that the non-important samples NIS are mostly within ±1.28 standard deviation. Discarding these non-important samples NIS helps to solve the imbalance issue of the modeling samples, and using the important samples IS can improve the prediction accuracy, i.e., conducting TL with the retained data improves the prediction accuracy. In addition, the extreme MAE value, all MAE value and R² value have an improvement on prediction accuracy of 19.48%, 3.25% and 8.35%, respectively, thus being capable of showing the superiority of the present disclosure.

Furthermore, for the testing set, as the online model refreshing stage of the virtual metrology method 200 based on KIS and CNN of the present disclosure (Advanced AVMCNN with KIS) remedies the deficiency of the conventional model, the overall model prediction capability is significantly enhanced. The Advanced AVMCNN with KIS also greatly improves the poor prediction trend shown in the dotted squares of the testing set.

TABLE 1

| | MAE(Å) | | |
|---|---|---|---|
| Thickness | Extreme values | All | R² |
| Advanced AVM_{CNN} | 0.47 | 0.27 | 0.77 |
| Advanced AVM_{CNN} | 0.38 | 0.26 | 0.83 |
| with KIS | | | |
| MAE and R² | 19.48% | 3.25% | 8.35% |
| Improvement | | | |

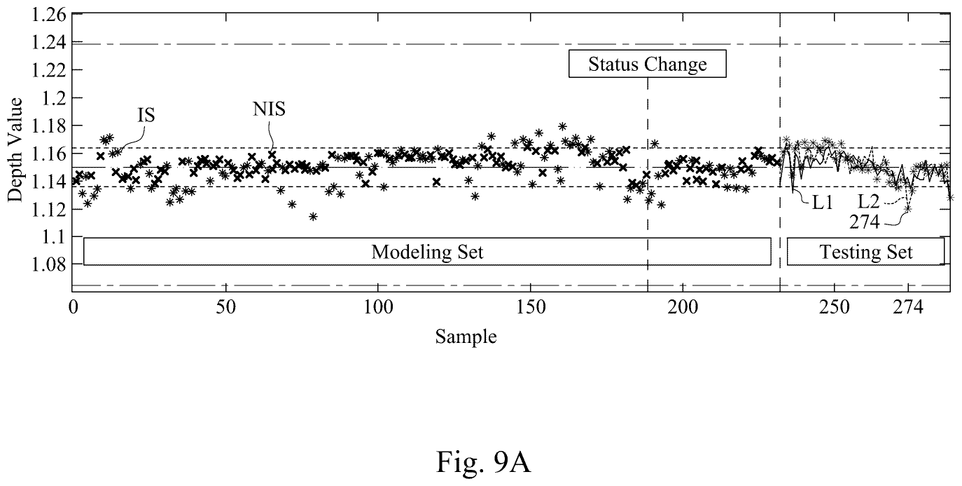

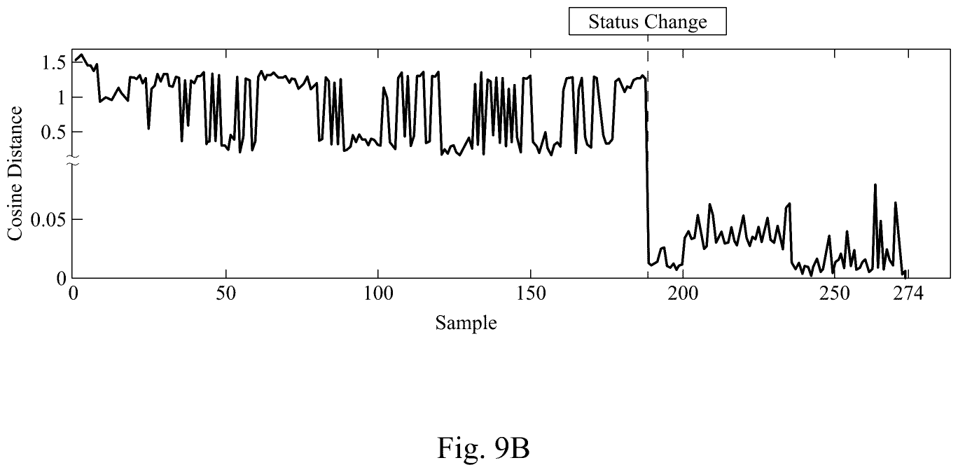

Reference is made to FIGS. 1, 2, 3, 4, 5, 6, 7A, 7B, 9A and 9B. FIG. 9A shows a schematic diagram of depth values of the application example regarding modeling set status change in a dry etching process of different prediction algorithms of the present disclosure. FIG. 9B shows a schematic diagram of cosine distances between sample ID 274 and other sample IDs of FIG. 9A. The production tool is corresponding to each of the phase-one virtual metrology value (VM_{I}) generated in the predicting step 300 and the phase-two virtual metrology value (VM_{II}) generated in the transfer learning step 400, and the production tool adopts a dry etching process of semiconductor manufacturing. In FIG. 9A, the horizontal axis represents the sample, and the vertical axis represents the depth value. A curve L1 represents the prediction result of the depth value when using only a virtual metrology method based on CNN (Advanced AVM_{CNN}). A curve L2 represents the prediction result of the depth value when using the virtual metrology method 200 based on KIS and CNN of the present disclosure (Advanced AVMCNN with KIS). In FIG. 9B, the horizontal axis represents the sample, and the vertical axis represents the cosine distance. Table 2 lists the prediction accuracies and R² values of the depth value of different prediction algorithms. In FIGS. 9A, 9B and Table 2, it can be clearly observed that the extreme MAE value, all MAE value and R² value have an improvement on prediction accuracy of 13.34%, 3.09% and 3.64%, respectively. In addition, the virtual metrology method 200 based on KIS and CNN of the present disclosure (Advanced AVMCNN with KIS) concisely retains the important samples IS and discards the non-important samples NIS, thereby avoiding the sample-imbalance issue and enabling the extreme value of the sample ID 274 to have better performance.

TABLE 2

| | MAE(Å) | | |
|---|---|---|---|
| Depth | Extreme values | All | R² |
| Advanced AVM_{CNN} | 80.62 | 53.63 | 0.78 |
| Advanced AVM_{CNN} | 69.87 | 51.97 | 0.81 |
| with KIS | | | |
| MAE and R² | 13.34% | 3.09% | 3.64% |
| Improvement | | | |

It can be understood that the virtual metrology method 200 based on KIS and CNN of the present disclosure is the above-mentioned implementation steps, and the computer program product of the present disclosure is used to perform the virtual metrology method 200 based on KIS and CNN. The order of each implementation step described in the above embodiments can be adjusted, combined or omitted as needed. The aforementioned embodiments can be provided as a computer program product, which may include a machine-readable medium on which instructions are stored for programming a computer (or other electronic devices) to perform a process based on the embodiments of the present disclosure. The machine-readable medium can be, but is not limited to, a floppy diskette, an optical disk, a compact disk-read-only memory (CD-ROM), a magneto-optical disk, a read-only memory (ROM), a random access memory (RAM), an erasable programmable read-only memory (EPROM), an electrically erasable programmable read-only memory (EEPROM), a magnetic or optical card, a flash memory, or another type of media/machine-readable medium suitable for storing electronic instructions. Moreover, the embodiments of the present disclosure also can be downloaded as a computer program product, which may be transferred from a remote computer to a requesting computer by using data signals via a communication link (such as a network connection or the like).

It is also noted that the present disclosure also can be described in the context of a manufacturing system. Although the present disclosure may be implemented in semiconductor fabrication, the present disclosure is not limited to implementation in semiconductor fabrication and may be applied to other manufacturing industries, in which the manufacturing system is configured to fabricate workpieces or products including, but not limited to, microprocessors, memory devices, digital signal processors, application specific integrated circuits (ASICs), or other similar devices. The present disclosure may also be applied to workpieces or manufactured products other than semiconductor devices, such as vehicle wheels, screws. The manufacturing system includes one or more processing tools that may be used to form one or more products, or portions thereof, in or on the workpieces (such as wafers, glass substrates). Persons of ordinary skill in the art should appreciate that the processing tools may be implemented in any number of entities of any type, including lithography tools, deposition tools, etching tools, polishing tools, annealing tools, machine tools, and the like. In the embodiments, the manufacturing system also includes one or more metrology tools, such as scatterometers, ellipsometers, scanning electron microscopes, and the like.

According to the aforementioned embodiments and examples, the advantages of the present disclosure are described as follows.

1. The virtual metrology method based on KIS and CNN and the system thereof of the present disclosure utilize a downsampling-based KIS scheme based on CAE, K-means, and cosine distance. The KIS scheme aims to balance the retention of the important samples within each value range for effectively resolving the imbalance problem and enhancing the model's learning effectiveness during fine-tuning, which facilitates advanced automatic virtual metrology to have wider application in the more and more sophisticated semiconductor industry.

2. The virtual metrology method based on KIS and CNN and the system thereof of the present disclosure utilize the dual-phase algorithm improved by adopting the online KIS scheme. The important samples are selected to achieve real-time model refreshing and avoid the sample-imbalance issue when new samples come in. In addition, in the time-varying system, the dual-phase algorithm improved by adopting the online KIS scheme possesses the ability of model refreshing and improves the learning efficiency of the model during the fine-tuning process to ensure good prediction accuracy.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A virtual metrology method based on keep important samples (KIS) and convolutional neural network (CNN), comprising:
configuring a processor to obtain a plurality of sets of process data, wherein the sets of process data are used or generated by a production tool when a plurality of workpieces are processed by the production tool, and the sets of process data are one-to-one corresponding to the workpieces, and each of the sets of process data comprises values of a plurality of parameters, and values of each of the parameters are respectively corresponding to a plurality of sets of time series data of the workpieces, and each of the sets of time series data has a data length;
configuring the processor to perform a data alignment operation onto the sets of process data, and the data alignment operation comprising:
performing a data-length adjusting operation to repeat adding at least one data point having a value of an end data point of each of the sets of time series data of each of the parameters after the end data point until the data length of each of the sets of time series data of each of the parameters is equal to a longest data length of the sets of process data; obtaining a plurality of actual metrology values of the workpieces;
configuring the processor to perform a modeling operation, the modeling operation comprising:
classifying the sets of process data and the actual metrology values into a plurality of paired data and at least one unpaired process data, wherein each of the paired data comprises one of the sets of process data and one of the actual metrology values corresponding to the one of the sets of process data; and
creating at least one pre-trained model by using the at least one unpaired process data, performing a keep important samples operation on the paired data to generate a plurality of important samples, and then inputting the important samples to the at least one pre-trained model to create a virtual metrology model based on convolutional autoencoder with keep important samples, wherein the virtual metrology model based on convolutional autoencoder with keep important samples comprises at least one convolutional neural network model; and
configuring the processor to perform a calculating operation, the calculating operation comprising:
obtaining at least one of another set of process data and another actual metrology value of another workpiece, and executing one of a predicting step and a transfer learning step according to whether the another actual metrology value is obtained, thereby calculating one of a phase-one virtual metrology value and a phase-two virtual metrology value of the another workpiece;
wherein the transfer learning step comprises performing calculations according to the virtual metrology model based on convolutional autoencoder with keep important samples, and a number of the important samples is smaller than a number of the paired data.

2. The virtual metrology method based on KIS and CNN of claim 1, wherein the keep important samples operation comprises:
judging that each of the paired data belongs to one of an extreme keeping group and a selective keeping group according to a distribution of the paired data, and performing downsampling on a part of the paired data belonging to the selective keeping group to obtain a plurality of keeping data, wherein the important samples comprise another part of the paired data belonging to the extreme keeping group and the keeping data.

3. The virtual metrology method based on KIS and CNN of claim 2, wherein the distribution of the paired data is a normal distribution, and the keep important samples operation further comprises:
dividing the normal distribution into the extreme keeping group and the selective keeping group according to a judgment condition, and dividing the paired data into the part of the paired data and the another part of the paired data according to the extreme keeping group and the selective keeping group.

4. The virtual metrology method based on KIS and CNN of claim 3, wherein the judgment condition is calculated as follows:
$$p {σ}_{y} \leq \frac{{y}_{í} - \overline{y}}{{σ}_{y}} ; \\ and \\ \frac{{y}_{i} - \overline{y}}{{σ}_{y}} < - p {σ}_{y} ;$$
wherein p represents a parameter which is greater than 1 and smaller than or equal to 2; yᵢ represents ith actual metrology value; y̅ represents an average value of yᵢ; σ_{y} represents a standard deviation of yᵢ, y̅ and σ_{y} are calculated as follows:
$$\overline{y} = \frac{{\sum }_{i = 1}^{n} {y}_{i}}{n} ; \\ and \\ {σ}_{y} = \sqrt{\frac{{( {y}_{i} - \overline{y} )}^{2}}{( n - 1 )}} ;$$
wherein n represents a sample size of yᵢ, in the normal distribution, the part of the paired data that meets the judgment condition belongs to the extreme keeping group, and the another part of the paired data that does not meet the judgment condition belongs to the selective keeping group.

5. The virtual metrology method based on KIS and CNN of claim 3, wherein the keep important samples operation further comprises:
clustering the another part of the paired data into a plurality of data groups according to a grouping algorithm, and setting a threshold value for the data groups, and calculating a group center and two percentage parameters of each of the data groups according to the threshold value, wherein the threshold value is represented by
$${D}_{cos {θ}_{{mk}_{T}}}$$
and calculated as follows:
$${D}_{co s {θ}_{{mk}_{T}}} = {\overline{{D}_{co s θ}}}_{mk} + α \times {σ}_{{D}_{co s {θ}_{mk}}} ; \\ {\overline{{D}_{co s θ}}}_{mk} = \frac{{\sum }_{c = 1}^{b} {\sum }_{b = c + 1}^{q} {D}_{co s {θ}_{mkcb}}}{( q \times \frac{q - 1}{2} )} ; \\ and \\ {σ}_{{D}_{co s {θ}_{mk}}} = \sqrt{\frac{{( ( {\sum }_{c = 1}^{b} {\sum }_{b = c + 1}^{q} {D}_{co s {θ}_{{mk}_{cb}}} ) - {\overline{{D}_{co s θ}}}_{mk} )}^{2}}{( q \times \frac{q - 1}{2} )}} ;$$
wherein [symbol] represents an average value of a cosine distance between two samples in kth cluster of the data groups of mth group;
$${σ}_{{D}_{cos {θ}_{mk}}}$$
represents a standard deviation of the cosine distance between the two samples in the kth cluster of the data groups of the mth group;
$${D}_{cos {θ}_{{mk}_{cb}}}$$
represents a cosine distance between a vector of bth sample and a vector of cth sample in the kth cluster of the data groups of the mth group; a represents a threshold setting factor; b and c belong to q and are different from each other; and q represents a sample number of the mth group.

6. The virtual metrology method based on KIS and CNN of claim 5, wherein the keep important samples operation further comprises:
segmenting one of the data groups into a plurality of sections according to the group center and the two percentage parameters; and
calculating a cosine distance between a sample in the one of the data groups and the group center, and performing an assignment sample operation according to the cosine distance between the sample in the one of the data groups and the group center, wherein the assignment sample operation is performed as follows:
$$\{ \begin{matrix}if {C}_{{g}_{m , k}} \leq {D}_{co s θ} ( \vec{{g}_{{mk}_{b}}} , \vec{{Cg}_{mk}} ) \leq {D}_{co s {θ}_{{mkP}_{75}}} , {g}_{m , {k}_{b}} ∈ {S}_{mk 1} \\ if {D}_{co s {θ}_{{mkP}_{75}}} \leq {D}_{co s θ} ( \vec{{g}_{{mk}_{b}}} , \vec{{Cg}_{mk}} ) \leq {D}_{co s {θ}_{{mkP}_{90}}} , {g}_{m , {k}_{b}} ∈ {S}_{mk 2} \\ otherwise , {g}_{m , {k}_{b}} ∈ {S}_{mk 3}\end{matrix} ;$$
wherein C_{g}_{_{m,k}} represents the group center; D_{cos θ}({right arrow over (gₘₖ_{_{b}})}, \vec{Cgₘₖ}) represents the cosine distance between the sample in the one of the data groups and the group center;
$${D}_{cos {θ}_{{mkP}_{75}}} and {D}_{cos {θ}_{{mkP}_{90}}}$$
represent the two percentage parameters; {right arrow over (gₘₖ_{_{b}} )} represents a vector of bth sample in the kth cluster of the data groups of the mth group; \vec{Cgₘₖ} represents a vector of the group center in the kth cluster of the data groups of the mth group; g_{m,k}_{_{b}} represents the bth sample in the kth cluster of the data groups of the mth group; Sₘₖₛ represents sth section in the kth cluster of the data groups of the mth group, and s is one of 1, 2 and 3.

7. The virtual metrology method based on KIS and CNN of claim 6, wherein the keep important samples operation further comprises:
calculating a cosine distance between two samples of the sth section in the kth cluster of the data groups of the mth group, wherein the cosine distance between the two samples of the sth section in the kth cluster of the data groups of the mth group is calculated as follows:
$${D}_{co s {θ}_{{S}_{{mks}_{ef}}}} = {D}_{co s θ} ( \vec{{S}_{{mks}_{e}}} , \vec{{S}_{{mks}_{f}}} ) ;$$
wherein \vec{Sₘₖₛ_{ₑ}} represents a vector of eth sample of the sth section in the kth cluster of the data groups of the mth group; {right arrow over (Sₘₖₛ_{_{f}} )} represents a vector of fth sample of the sth section in the kth cluster of the data groups of the mth group, and e and f are different from each other.

8. The virtual metrology method based on KIS and CNN of claim 7, wherein the keep important samples operation further comprises:
confirming whether a sample number of the sth section in the kth cluster of the data groups of the mth group is greater than a predetermined sample number to generate a confirmation result, and then deciding to execute an important sample selecting operation or an important sample obtaining operation according to the confirmation result; and
in response to determining that the confirmation result is yes, performing the important sample selecting operation, the important sample obtaining operation and an all sample checking operation in sequence; and in response to determining that the confirmation result is no, performing the important sample obtaining operation and the all sample checking operation in sequence;
wherein the important sample selecting operation comprises selecting three samples with a largest cosine distance in the sth section of the kth cluster of the data groups of the mth group, and moving the three samples into an important sample set;
wherein the important sample obtaining operation comprises obtaining the important samples of the important sample set;
wherein the all sample checking operation comprises confirming whether all samples are checked.

9. The virtual metrology method based on KIS and CNN of claim 7, wherein the transfer learning step of the calculating operation further comprises:
regarding the another actual metrology value as a new sample, and calculating a cosine distance between the new sample and the group center in the kth cluster of the data groups of the mth group, and performing the assignment sample operation according to the cosine distance between the new sample and the group center in the kth cluster of the data groups of the mth group, and confirming whether the new sample becomes another important sample.

10. The virtual metrology method based on KIS and CNN of claim 1, wherein,
the predicting step comprises calculating the phase-one virtual metrology value by the another set of process data according to the virtual metrology model based on convolutional autoencoder with keep important samples, and the transfer learning step further comprises calculating the phase-two virtual metrology value by the another set of process data and the another actual metrology value according to the virtual metrology model based on convolutional autoencoder with keep important samples;
the virtual metrology model based on convolutional autoencoder with keep important samples controls the production tool to process the workpieces; and
the production tool is corresponding to each of the phase-one virtual metrology value generated in the predicting step and the phase-two virtual metrology value generated in the transfer learning step, and the production tool adopts a dry etching process of semiconductor manufacturing.

11. A virtual metrology system based on keep important samples (KIS) and convolutional neural network (CNN), comprising:
a memory configured to store a plurality of sets of process data and a plurality of actual metrology values of a plurality of workpieces, wherein the sets of process data are used or generated by a production tool when the workpieces are processed by the production tool, and the sets of process data are one-to-one corresponding to the workpieces, and each of the sets of process data comprises values of a plurality of parameters, and values of each of the parameters are respectively corresponding to a plurality of sets of time series data of the workpieces, and each of the sets of time series data has a data length; and
a processor electrically connected to the memory, wherein the processor receives the sets of process data and the actual metrology values, and is configured to:
perform a data alignment operation onto the sets of process data, and the data alignment operation comprising:
performing a data-length adjusting operation to repeat adding at least one data point having a value of an end data point of each of the sets of time series data of each of the parameters after the end data point until the data length of each of the sets of time series data of each of the parameters is equal to a longest data length of the sets of process data;
perform a modeling operation, the modeling operation comprising:
classifying the sets of process data and the actual metrology values into a plurality of paired data and at least one unpaired process data, wherein each of the paired data comprises one of the sets of process data and one of the actual metrology values corresponding to the one of the sets of process data; and
creating at least one pre-trained model by using the at least one unpaired process data, performing a keep important samples operation on the paired data to generate a plurality of important samples, and then inputting the important samples to the at least one pre-trained model to create a virtual metrology model based on convolutional autoencoder with keep important samples, wherein the virtual metrology model based on convolutional autoencoder with keep important samples comprises at least one convolutional neural network model; and
perform a calculating operation, the calculating operation comprising:
obtaining at least one of another set of process data and another actual metrology value of another workpiece, and executing one of a predicting step and a transfer learning step according to whether the another actual metrology value is obtained, thereby calculating one of a phase-one virtual metrology value and a phase-two virtual metrology value of the another workpiece;
wherein the transfer learning step comprises performing calculations according to the virtual metrology model based on convolutional autoencoder with keep important samples, and a number of the important samples is smaller than a number of the paired data.

12. The virtual metrology system based on KIS and CNN of claim 11, wherein the keep important samples operation comprises:
judging that each of the paired data belongs to one of an extreme keeping group and a selective keeping group according to a distribution of the paired data, and performing downsampling on a part of the paired data belonging to the selective keeping group to obtain a plurality of keeping data, wherein the important samples comprise another part of the paired data belonging to the extreme keeping group and the keeping data.

13. The virtual metrology system based on KIS and CNN of claim 12, wherein the distribution of the paired data is a normal distribution, and the keep important samples operation further comprises:
dividing the normal distribution into the extreme keeping group and the selective keeping group according to a judgment condition, and dividing the paired data into the part of the paired data and the another part of the paired data according to the extreme keeping group and the selective keeping group.

14. The virtual metrology system based on KIS and CNN of claim 13, wherein the judgment condition is calculated as follows:
$$p {σ}_{y} \leq \frac{{y}_{í} - \overline{y}}{{σ}_{y}} ; \\ and \\ \frac{{y}_{i} - \overline{y}}{{σ}_{y}} < - p {σ}_{y} ;$$
wherein p represents a parameter which is greater than 1 and smaller than or equal to 2; yᵢ represents ith actual metrology value; y̅ represents an average value of yᵢ; σ_{y} represents a standard deviation of yᵢ, y̅ and σ_{y} are calculated as follows:
$$\overline{y} = \frac{{\sum }_{i = 1}^{n} {y}_{i}}{n} ; \\ and \\ {σ}_{y} = \sqrt{\frac{{( {y}_{i} - \overline{y} )}^{2}}{( n - 1 )}} ;$$
wherein n represents a sample size of yᵢ, in the normal distribution, the part of the paired data that meets the judgment condition belongs to the extreme keeping group, and the another part of the paired data that does not meet the judgment condition belongs to the selective keeping group.

15. The virtual metrology system based on KIS and CNN of claim 13, wherein the keep important samples operation further comprises:
clustering the another part of the paired data into a plurality of data groups according to a grouping algorithm, and setting a threshold value for the data groups, and calculating a group center and two percentage parameters of each of the data groups according to the threshold value, wherein the threshold value is represented by
$${D}_{cos {θ}_{{mk}_{T}}}$$
and calculated as follows:
$${D}_{co s {θ}_{{mk}_{T}}} = {\overline{{D}_{co s θ}}}_{mk} + α \times {σ}_{{D}_{co s {θ}_{mk}}} ; \\ {\overline{{D}_{co s θ}}}_{mk} = \frac{{\sum }_{c = 1}^{b} {\sum }_{b = c + 1}^{q} {D}_{co s {θ}_{mkcb}}}{( q \times \frac{q - 1}{2} )} ; \\ and \\ {σ}_{{D}_{co s {θ}_{mk}}} = \sqrt{\frac{{( ( {\sum }_{c = 1}^{b} {\sum }_{b = c + 1}^{q} {D}_{co s {θ}_{{mk}_{cb}}} ) - {\overline{{D}_{co s θ}}}_{mk} )}^{2}}{( q \times \frac{q - 1}{2} )}} ;$$
wherein [symbol] represents an average value of a cosine distance between two samples in kth cluster of the data groups of mth group;
$${σ}_{{D}_{cos {θ}_{mk}}}$$
represents a standard deviation of the cosine distance between the two samples in the kth cluster of the data groups of the mth group;
$${D}_{cos {θ}_{{mk}_{cb}}}$$
represents a cosine distance between a vector of bth sample and a vector of cth sample in the kth cluster of the data groups of the mth group; a represents a threshold setting factor; b and c belong to q and are different from each other; and q represents a sample number of the mth group.

16. The virtual metrology system based on KIS and CNN of claim 15, wherein the keep important samples operation further comprises:
segmenting one of the data groups into a plurality of sections according to the group center and the two percentage parameters; and
calculating a cosine distance between a sample in the one of the data groups and the group center, and performing an assignment sample operation according to the cosine distance between the sample in the one of the data groups and the group center, wherein the assignment sample operation is performed as follows:
$$\{ \begin{matrix}if {C}_{{g}_{m , k}} \leq {D}_{co s θ} ( \vec{{g}_{{mk}_{b}}} , \vec{{Cg}_{mk}} ) \leq {D}_{co s {θ}_{{mkP}_{75}}} , {g}_{m , {k}_{b}} ∈ {S}_{mk 1} \\ if {D}_{co s {θ}_{{mkP}_{75}}} \leq {D}_{co s θ} ( \vec{{g}_{{mk}_{b}}} , \vec{{Cg}_{mk}} ) \leq {D}_{co s {θ}_{{mkP}_{90}}} , {g}_{m , {k}_{b}} ∈ {S}_{mk 2} \\ otherwise , {g}_{m , {k}_{b}} ∈ {S}_{mk 3}\end{matrix} ;$$
wherein C_{g}_{_{m,k}} represents the group center; D_{cos θ}({right arrow over (gₘₖ_{_{b}})}, \vec{Cgₘₖ}) represents the cosine distance between the sample in the one of the data groups and the group center;
$${D}_{cos {θ}_{{mkP}_{75}}} and {D}_{cos {θ}_{{mkP}_{90}}}$$
represent the two percentage parameters; {right arrow over (gₘₖ_{_{b}} )} represents a vector of bth sample in the kth cluster of the data groups of the mth group; \vec{Cgₘₖ} represents a vector of the group center in the kth cluster of the data groups of the mth group; g_{m,k}_{_{b}} represents the bth sample in the kth cluster of the data groups of the mth group; Sₘₖₛ represents sth section in the kth cluster of the data groups of the mth group, and s is one of 1, 2 and 3.

17. The virtual metrology system based on KIS and CNN of claim 16, wherein the keep important samples operation further comprises:
calculating a cosine distance between two samples of the sth section in the kth cluster of the data groups of the mth group, wherein the cosine distance between the two samples of the sth section in the kth cluster of the data groups of the mth group is calculated as follows:
$${D}_{co s {θ}_{{S}_{{mks}_{ef}}}} = {D}_{co s θ} ( \vec{{S}_{{mks}_{e}}} , \vec{{S}_{{mks}_{f}}} ) ;$$
wherein \vec{Sₘₖₛ_{ₑ}} represents a vector of eth sample of the sth section in the kth cluster of the data groups of the mth group; {right arrow over (Sₘₖₛ_{_{f}} )} represents a vector of fth sample of the sth section in the kth cluster of the data groups of the mth group, and e and f are different from each other.

18. The virtual metrology system based on KIS and CNN of claim 17, wherein the keep important samples operation further comprises:
confirming whether a sample number of the sth section in the kth cluster of the data groups of the mth group is greater than a predetermined sample number to generate a confirmation result, and then deciding to execute an important sample selecting operation or an important sample obtaining operation according to the confirmation result; and
in response to determining that the confirmation result is yes, performing the important sample selecting operation, the important sample obtaining operation and an all sample checking operation in sequence; and in response to determining that the confirmation result is no, performing the important sample obtaining operation and the all sample checking operation in sequence;
wherein the important sample selecting operation comprises selecting three samples with a largest cosine distance in the sth section of the kth cluster of the data groups of the mth group, and moving the three samples into an important sample set;
wherein the important sample obtaining operation comprises obtaining the important samples of the important sample set;
wherein the all sample checking operation comprises confirming whether all samples are checked.

19. The virtual metrology system based on KIS and CNN of claim 17, wherein the transfer learning step of the calculating operation further comprises:
regarding the another actual metrology value as a new sample, and calculating a cosine distance between the new sample and the group center in the kth cluster of the data groups of the mth group, and performing the assignment sample operation according to the cosine distance between the new sample and the group center in the kth cluster of the data groups of the mth group, and confirming whether the new sample becomes another important sample.

20. The virtual metrology system based on KIS and CNN of claim 11, wherein,
the predicting step comprises calculating the phase-one virtual metrology value by the another set of process data according to the virtual metrology model based on convolutional autoencoder with keep important samples, and the transfer learning step further comprises calculating the phase-two virtual metrology value by the another set of process data and the another actual metrology value according to the virtual metrology model based on convolutional autoencoder with keep important samples;
the virtual metrology model based on convolutional autoencoder with keep important samples controls the production tool to process the workpieces; and
the production tool is corresponding to each of the phase-one virtual metrology value generated in the predicting step and the phase-two virtual metrology value generated in the transfer learning step, and the production tool adopts a dry etching process of semiconductor manufacturing.
